(19) United States
(12) Patent Application Publication
(10) Pub. No.: US 2025/0053387 A1
(43) Pub. Date: Feb. 13, 2025

(54) CENTRALIZED PROCESSES FOR FEATURE GENERATION AND MANAGEMENT WITHIN WEB-BASED COMPUTING ENVIRONMENTS

(71) Applicant: The Toronto-Dominion Bank, Toronto (CA)

(72) Inventors: Hui-Jann WANG, Toronto (CA); Jingwen LI, Markham (CA); Jingjing LIU, Oakville (CA); Mona FADAVIARDAKANI, Vancouver (CA); Wenjia ZHU, Vancouver (CA)

(21) Appl. No.: 18/796,667

(22) Filed: Aug. 7, 2024

Related U.S. Application Data
(60) Provisional application No. 63/531,242, filed on Aug. 7, 2023.

(51) Int. Cl. G06F 8/34; G06F 8/30

(52) U.S. Cl. CPC G06F 8/34; G06F 8/31

(57) ABSTRACT

The disclosed embodiments include centralized, computer-implemented processes for feature generation and management within web-based computing environments. By way of example, an apparatus may transmit first data characterizing a plurality of features to a device, the first data causes the device to present interface elements associated with the features within a digital interface. The apparatus may receive second data that identifies at least a subset of the features from the device, and based on the second data, the apparatus may generate, for each of the subset of the features, elements of executable code associated with a calculation of a corresponding feature value. The apparatus may transmit third data that includes the elements of executable code to the device, which may present the elements of executable code within one or more additional portions of the digital interface.

### CROSS-REFERENCE TO RELATED APPLICATION

This application claims the benefit of priority under 35 U.S.C. § 119 (e) to prior U.S. Application No. 63/531,242, filed Aug. 7, 2023, the disclosure of which is incorporated by reference herein to its entirety.

### TECHNICAL FIELD

The disclosed embodiments generally relate to centralized, computer-implemented processes for feature generation and management within web-based computing environments.

### BACKGROUND

Today, machine-learning processes are widely adopted throughout many organizations and enterprises, and inform both user-or customer-facing decisions and back-end decisions. Many machine-learning processes operate, however, as “black boxes,” and lack transparency regarding the importance and relative impact of certain input features, or combinations of certain input features, on the operations of these machine-learning processes and on the output generated by these machine-learning and processes. Further, many of existing machine-learning processes are developed in response to specific use-cases, and are incapable of flexible deployment across multiple uses cases without significant modification and adaption by experienced developers and data scientists.

### SUMMARY

In some examples, an apparatus includes a communications interface, a memory storing instructions, and at least one processor coupled to the communications interface and to the memory. The at least one processor is configured to execute the instructions to transmit, to a device via the communications interface, first data characterizing a plurality of features. The first data causes an application program executed by the device to present interface elements associated with the features within one or more portions of a digital interface. The at least one processor is further configured to execute the instructions to receive second data that identifies at least a subset of the features from the device via the communications interface, and based on the second data, generate, for each of the subset of the features, elements of executable code associated with a calculation of a corresponding feature value. The at least one processor is further configured to execute the instructions to transmit third data that includes the elements of executable code to the device via the communications interface. The third data causes the executed application program to present the elements of executable code within one or more additional portions of the digital interface.

In other examples, a computer-implemented method includes, using at least one processor, transmitting, to a device, first data characterizing a plurality of features. The first data causes an application program executed by the device to present interface elements associated with the features within one or more portions of a digital interface. The computer-implemented method includes receiving, from the device, and using the at least one processor, second data that identifies at least a subset of the features, and based on the second data, generating, using the at least one processor, elements of executable code associated with a calculation of a corresponding feature value for each of the subset of the features. The computer-implemented method includes transmitting third data that includes the elements of executable code to the device using the at least one processor, the third data causing the executed application program to present the elements of executable code within one or more additional portions of the digital interface.

Further, in some examples, a device includes a communications interface, a memory storing instructions, and at least one processor coupled to the communications interface and to the memory. The at least one processor is configured to execute the instructions to receive, via the communication interface, first data characterizing a plurality of features, and perform operations that present interface elements associated with the features within one or more portions of a digital interface. The at least one processor is further configured to execute the instructions to obtain second data indicative of a selection of at least a subset of the features, and transmit at least a portion of the second data to a computing system via the communications interface. The computing system is configured to generate, based on the portion of the second data, elements of executable code associated with a calculation of a corresponding feature value for each of the subset of the features. The at least one processor is further configured to execute the instructions to receive third data that includes the elements of executable code to the computing system via the communications interface, and perform operations that present the elements of executable code within one or more additional portions of the digital interface.

The details of one or more exemplary embodiments of the subject matter described in this specification are set forth in the accompanying drawings and the description below. Other potential features, aspects, and advantages of the subject matter will become apparent from the description, the drawings, and the claims.

### BRIEF DESCRIPTION OF THE DRAWINGS

FIGS. 1, 2A-2D and 3A are block diagrams illustrating portions of an exemplary computing environment, in accordance with some exemplary embodiments.

FIGS. 3B-3E are diagrams illustrating exemplary portions of a digital interface, in accordance with some exemplary embodiments.

FIGS. 3F, 4A, and 4B are block diagrams illustrating portions of an exemplary computing environment, in accordance with some exemplary embodiments.

FIGS. 4C-4F are diagrams illustrating exemplary portions of a digital interface, in accordance with some exemplary embodiments.

FIGS. 5A, 5B, and 5C are flowcharts of exemplary processes for managing feature generation within interactive, web-based computing environments, in accordance with some exemplary embodiments.

Like reference numbers and designations in the various drawings indicate like elements.

### DETAILED DESCRIPTION

Many organizations and enterprises rely on a predicted output of machine-learning processes to support and inform a variety of decisions and strategies. These organizations and enterprises may include, among other things, operators of distributed and cloud-based computing environments, financial institutions, physical or digital retailers, or entities in the entertainment or lodging industries. In some instances, the decisions and strategies informed by the predicted output of machine-learning processes may include customer-or user-facing decisions, such as decisions associated with the provisioning of resources, products or services in response to customer-or user-specific requests, and back-end decisions, such as decisions associated with an allocation of physical, digital, or computational resources among geographically dispersed users or customers, and decisions associated with a determined use, or misuse, of these allocated resources by the users or customers.

Further, these organizations and enterprises do not rely on the predictive output of a single machine-learning process, but often instead rely on the predictive output of dozens, if not hundreds, of discrete, trained machine-learning processes to inform decisions and strategies on a daily, monthly, or quarterly basis. Each of these discrete, machine-learning processes be may associated with a corresponding feature-engineering, training, inferencing, and in some instances, monitoring operations subject to concurrent execution in accordance with process-, and output-specific, schedules. Despite similarities or commonalities in process types, process configurations, data sources, or targeted events across the discrete, machine-learning processes, the feature-engineering, training, inferencing, and monitoring processes associated with many machine-learning processes are characterized by fixed execution flows of sequential operations established by static, process-specific executable scripts, and by discrete, executable application modules or engines that are generated by data scientists in conformity within the particular use case and that perform static and inflexible process-specific operations.

The reliance on fixed execution flows, status executable scripts, and hand-coded, use-case-specific executable application modules or engines to perform static, and inflexible, process-specific operations may, in some instances, discourage wide option of machine-learning technologies within many organizations. For example, the generation of hand-coded scripts or executable application modules or engines for each use-case of a machine-learning process may result in duplicative and redundant effort by data scientists, e.g., as the multiple uses cases may be associated one or more common hard-coded scripts or executable application engines. Further, the time delay associated with the generation of these hand-coded scripts or executable application modules or engines, and with the post-training and pre-deployment validation of each of the machine-learning processes trained via the execution of corresponding ones of the hand-coded scripts or executable application modules or engines, may reduce a relevance of the predictive output to the decisioning processes of these organizations and render impractical real-time experimentation in the feature-generation or feature selection processes.

Additionally, in some examples, a development of, and experimentation with, adaptive training and inference processes that rely on these hard-coded scripts or executable application engines may be impractical for all but experienced developers, data scientists, and engineers, who possess the specific skills required to generate and deploy the hard-coded scripts or executable application engines within the distributed computing environment. Further, the specific skills maintained by these experienced developers, data scientists, and engineers rarely experience wide dissemination across the organization or enterprise, and attrition involving these experienced developers, data scientists, and engineers often results in a significant knowledge deficit within the organization or enterprise.

### A. Exemplary Computing Environments

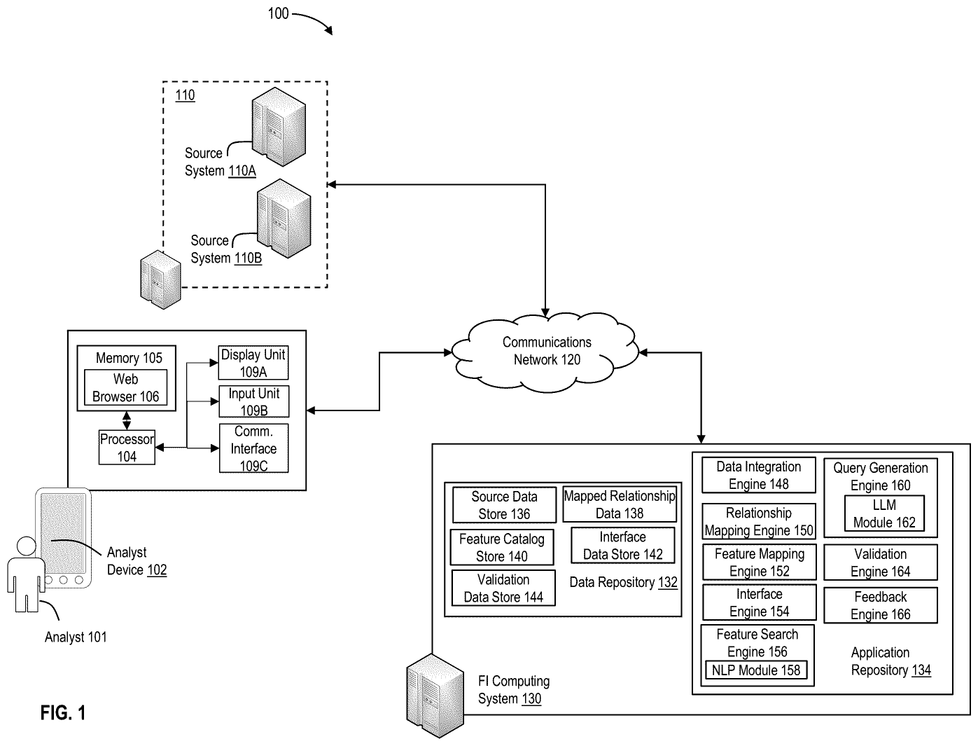

FIG. 1 illustrates an exemplary computing environment 100 that includes, among other things, one or more computing devices, such as an analyst device 102. Environment 100 may also include, among other things, one or more source systems 110, such as, but not limited to, source system 110A and source system 110B, and a computing system operable by an organization of enterprise, such as, but not limited to, a computing system 130. In some instances, each of the one or more computing devices, including analyst device 102, each of source systems 110 (including source system 110A and source system 110B), and computing system 130 may be operatively connected to, and interconnected across, one or more communications networks, such as communications network 120. Examples of communications network 120 include, but are not limited to, a wireless local area network (LAN) (e.g., a “Wi-Fi” network), a network utilizing radiofrequency (RF) communication protocols, a Near Field Communication (NFC) network, a wireless Metropolitan Area Network (MAN) connecting multiple wireless LANs, and a wide area network (WAN) (e.g., the Internet).

Analyst device 102 may include a computing device having one or more tangible, non-transitory memories, such as memory 105, that store data and/or software instructions, and one or more processors, such as, processor 104, configured to execute the software instructions. For example, the one or more tangible, non-transitory memories, such as memory 105, may store one or more software applications, application engines, and other elements of code executable by processor 104, such as, but not limited to, an executable web browser 106 (e.g., Google Chrome™, Apple Safari™, etc.) capable of interacting with one or more web servers established programmatically by computing system 130. By way of example, and upon execution by the one or more processors, web browser 106 may interact programmatically with the one or more web servers of computing system 130 via a web-based interactive computational environment, such as a Juypter™ notebook or a Databricks™ notebook. Further, although not illustrated in FIG. 1, memory 105 may also include one or more structured or unstructured data repositories or databases, and analyst device 102 may maintain one or more elements of device data and location data within the one or more structured or unstructured data repositories or databases. For example, the elements of device data may uniquely identify analyst device 102 within computing environment 100, and may include, but are not limited to, an Internet Protocol (IP) address assigned to analyst device 102 or a media access control (MAC) layer assigned to analyst device 102.

Analyst device 102 may also include a display device 109A configured to present interface elements to a corresponding user and an input device 109B configured to receive input from the user. For example, input device 109B configured to receive input from the user in response to the interface elements presented through display device 109A. By way of example, display device 109A may include, but is not limited to, an LCD display unit or other appropriate type of display unit, and input device 109B may include, but is not limited to, a keypad, keyboard, touchscreen, voice activated control technologies, or appropriate type of input unit. Further, in additional instances (not illustrated in FIG. 1), the functionalities of display device 109A and input device 109B may be combined into a single device, such as, a pressure-sensitive touchscreen display unit that presents interface elements and receives input from the user of analyst device 102. Analyst device 102 may also include a communications interface 109C, such as a wireless transceiver device, coupled to processor 104 and configured by processor 104 to establish and maintain communications with communications network 120 via one or more communication protocols, such as WiFi®, Bluetooth®, NFC, a cellular communications protocol (e.g., LTER, CDMA®, GSM®, etc.), or any other suitable communications protocol.

Examples of analyst device 102 may include, but not limited to, a personal computer, a laptop computer, a tablet computer, a notebook computer, a hand-held computer, a personal digital assistant, a portable navigation device, a mobile phone, a smart phone, a wearable computing device (e.g., a smart watch, a wearable activity monitor, wearable smart jewelry, and glasses and other optical devices that include optical head-mounted displays (OHMDs), an embedded computing device (e.g., in communication with a smart textile or electronic fabric), and any other type of computing device that may be configured to store data and software instructions, execute software instructions to perform operations, and/or display information on an interface device or unit, such as display device 109A. In some instances, analyst device 102 may also establish communications with one or more additional computing systems or devices operating within computing environment 100 across a wired or wireless communications channel (via the communications interface 109C using any appropriate communications protocol). Further, a user, such as an analyst 101, may operate analyst device 102 and may do so to cause analyst device 102 to perform one or more exemplary processes described herein.

In some examples, source systems 110 (including source system 110A and source system 110B) and computing system 130 may each represent a computing system that includes one or more servers and tangible, non-transitory memories storing executable code and application modules. Further, the one or more servers may each include one or more processors, which may be configured to execute portions of the stored code or application modules to perform operations consistent with the disclosed embodiments. For example, the one or more processors may include a central processing unit (CPU) capable of processing a single operation (e.g., a scalar operations) in a single clock cycle. Further, each of source systems 110 (including source system 110A and source system 110B) and computing system 130 may also include a communications interface, such as one or more wireless transceivers, coupled to the one or more processors for accommodating wired or wireless internet communication with other computing systems and devices operating within computing environment 100.

Further, in some instances, source systems 110 (including source system 110A, and source system 110B) and computing system 130 may each be incorporated into a respective, discrete computing system. In additional, or alternate, instances, one or more of source systems 110 (including source system 110A, and source system 110B) and computing system 130 may correspond to a distributed computing system having a plurality of interconnected, computing components distributed across an appropriate computing network, such as communications network 120 of FIG. 1. By way of example, all, or subset, of source systems 110 may correspond to a distributed or cloud-based computing cluster associated with, and maintained by, the organization, or to a publicly accessible, distributed or cloud-based computing cluster (e.g., a computing cluster maintained by Microsoft Azure™, Amazon Web Services™, Google Cloud™, or another third-party provider), and may collectively establish an enterprise data warehouse or data lake the provisions source data tables computing system 130 in accordance with a predetermined (or dynamically determined) schedule or on a continuous basis, e.g., as Data-as-a-Service (DaaS) data. Additionally, and as described herein, the interconnected and distributed computing components of computing system 130 may correspond to a distributed or cloud-based computing cluster associated with, and maintained by, the financial institution, although in other examples, interconnected and distributed computing components of computing system 130 may correspond to a publicly accessible, distributed or cloud-based computing cluster, such as a computing cluster maintained by Microsoft Azure™, Amazon Web Services™, Google Cloud™, or another third-party provider.

By way of example, computing system 130 may include a corresponding plurality of interconnected, distributed computing components, such as those described herein (not illustrated in FIG. 1), which may be configured to implement one or more parallelized, fault-tolerant distributed computing and analytical processes (e.g., an Apache Spark™ distributed, cluster-computing framework, a Databricks™ analytical platform, etc.). Further, and in addition to the CPUs described herein, the distributed computing components of computing system 130 may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Through an implementation of the parallelized, fault-tolerant distributed computing and analytical protocols described herein, the distributed computing components of computing system 130 may perform any of the exemplary processes described herein to, among other things, ingest source data tables associated with customers of the organization and corresponding events (e.g., transactions, etc.) involving these customers, preprocess the ingested data tables in accordance with a modular data format (e.g., consistent with Data Vault 2.0™ protocols) and store the pre-processed data tables within an accessible data repository (e.g., within a portion of a distributed file system, such as a Hadoop distributed file system (HDFS)), and dynamically map associations and relationships within the pre-processed data tables based on the modular data format. Based on the dynamically mapped relationships and association within the pre-processed data tables, and based on an analyst's selection of (i) a dimension of the data maintained within the pre-processed data tables and (ii) one or more catalogued features associated with the selected dimension, the distributed computing components of computing system 130 may also perform any of the exemplary processes described herein to generate dynamically elements of executable code (e.g., in a Python™ format or a structured query language (SQL) format) that, when executed a device operable by the analyst (e.g., analyst device 102), join together the pre-processed data tables associated with the selected data dimension and the selected features, filter the joined data tables in accordance with an analyst-specified temporal filter, and generate each of the selected features.

Further, through an implementation of the parallelized, fault-tolerant distributed computing and analytical protocols described herein, the distributed computing components of computing system 130 may perform any of the exemplary processes described herein to, among other things, apply a trained, large-language model, such as, but not limited to, a pre-trained generative transformer (e.g., a GPT 3.5 or GPT 4 process, such as ChatGPT) to the elements of dynamically generated code, and based on the application of the trained, large-language model to the elements of dynamically generated code, the trained, large-language model may generate additional elements of executable code that apply one or more customized, analyst-and use-case-specific manipulations or features to the selected feature (e.g., one or more additional temporal filters or temporal aggregations, other manipulations, etc.). The implementation of the parallelized, fault-tolerant distributed computing and analytical protocols described herein across the one or more GPUs or TPUs included within the distributed components of computing system 130 may, in some instances, optimize or accelerate an end-to-end process of extracting, transforming, and loading data (ETL), developing features in support of process training or inferencing, while maintaining consistency between training and production environments, and may serve as a bridge between data engineers, data scientists, analysts, and machine-learning or artificial-intelligence processes and analytics and that addresses common technological challenges in the field of data science and analytics, e.g., by centralizing, optimizing, and open-sourcing feature generation and management.

Referring back to FIG. 1, and to facilitate a performance of one or more of these exemplary processes, computing system 130 may maintain, within the one or more tangible, non-transitory memories, a data repository 132 and an application repository 134, which includes one or more application engines, application modules, or other code elements executed by the one or more processors of computing system 130 (e.g., via one or more of the distributed computing components of computing system 130). By way of example, data repository 132 may maintain, among other things, one or more a source data store 136, elements of mapped relationship data 138, a feature catalog store 140, an interface data store 142, and a validation data store 144. Further, as illustrated in FIG. 1, application repository 134 may include, among other things, and executable data integration engine 148, an executable relationship mapping engine 150, an executable feature mapping engine 152, an executable interface engine 154, an executable feature search engine 156 (including an executable natural language processing (NLP) module 158), an executable query generation engine 160 (including an executable large language model (LLM) module 162), an executable validation engine 164, and an executable feedback engine 166.

Upon execution by the one or more processors of computing system 130, data integration engine 148 may perform operations, described here in, that access corresponding ones of source systems 110A (including source system 110A and/or source data system 110B), and obtain (or “ingest”) one or more source data tables in accordance with a predetermined, temporal schedule (e.g., on a daily basis, a weekly basis, a monthly basis, etc.) or on a continuous, streaming basis, e.g., as Data-as-a-Service (DaaS) data. Executed data integration engine 148 may store each of the ingested source data tables within a corresponding portion of source data store 136 of data repository 132, and further, may perform operations, described herein, that apply one or more data pre-processing operations, and additionally or alternatively, one or more extract, transform, or load (ETL) operations, to corresponding elements the ingested source data tables in accordance with a modular data format, such as, but not limited to, a Data Vault 2.0™ protocol.

Further, and upon execution by the one or more processors of computing system 130, relationship mapping engine 150 may access each, or a selected subset, of source data tables 212, and based on an application of one or more dynamic mapping operations consistent with the modular data format (e.g., the Data Vault 2.0™ protocol) to the accessed ones of source data tables 212, executed relationship mapping engine 150 may perform operations that dynamically map associations and relationships between corresponding ones of source data tables 212, and additionally, or alternatively, between rows and columns of the corresponding ones of source data tables 212. In some instances, executed relationship mapping engine 150 may perform operations that store the mapped data tables and data characterizing the mapped associations and relationships within an additional portion (e.g., the business keys, associated attribute tables, and associated derived attribute tables, as described herein) within a portion of the one or more tangible, non-transitory memories of computing system 130, e.g., within mapped relationship data 138.

In some instances, and upon execution by the one or more processors of computing system 130, executed feature mapping engine 152 may access mapped relationship data 138, and may perform any of the exemplary processes described herein to identify and characterize one or more features that may be extracted or derived from corresponding ones of the mapped data tables, and store data specifying each of the identified and characterized features within a corresponding portion of the one or more tangible, non-transitory memories of computing system 130, e.g., within data records of feature catalog store 140. For example, and for a corresponding feature, the data records of feature catalog store 140 may maintain a corresponding feature name and an associated dimensionality of the feature, a corresponding feature category, an identifier of one or more of the source or mapped data tables (e.g., as maintained within mapped relationship data 138), a data flag characterize the corresponding feature as extracted or derived, and data characterizing a corresponding feature type, e.g., text-based, binary, categorical, or floating-point numerical. Additionally, and for each of the features, the data records of feature catalog store 140 may also include a textual description (e.g., in natural, human-readable language) of the feature and a relationship of that feature to a corresponding customer, account, transactional, or interaction-specific characteristic or behavior of a corresponding customer.

In some instances, executed feature mapping engine 152 may also perform one or more of the exemplary processes described herein to identify, and characterize, one or more database operations that, upon application to the mapped data tables maintained within mapped relationship data 138 (and/or to the source data tables maintained within source data store 136), facilitate a generation of, corresponding features identified and characterized within the data records of feature catalog store 140. By way of example, the one or more database operations may include, but are not limited to, an application of Java-based SQL “join” commands, such as appropriate “inner” or “outer” join command, to corresponding ones of the mapped relationship data 138, and executed feature mapping engine 152 may store data specifying each of the one or more feature-specific database operations within a corresponding data record of feature catalog store 140.

Further, and upon execution by the one or more processors of computing system 130 (e.g., via corresponding ones of the distributed computing components), interface engine 154 may perform operations that provision, to analyst device 102, elements of interface data maintained within interface data store 142 that, when presented to analyst 101 via display device 109A, establish a web-based graphical user interface (GUI) of an analytics feature store that facilitates an interaction of analyst 101 with the data records maintained within feature catalog store 140 and a selection of one or more of the catalogued features associated with a corresponding dimension of data maintained within a subset of the mapped data tables maintained within mapped relationship data 138, with corresponding, dimension-specific granularities or aggregation methods, and further with corresponding business keys associated with the subset of the mapped data tables. The presented GUI may, for example, prompt analyst 101 to provide input that searches for corresponding ones of the catalogued features based on, among other things, a feature name or based on an application of a trained, natural language process to portions of a structured or unstructured query and corresponding feature descriptions maintained by feature catalog store 140 (e.g., based on operations performed by NLP module 158 of feature search engine 156), and enable analyst 101 to provide input that specifies a temporal filter on the selected features (e.g., a range of dates), or one or more additional filters or data manipulations appropriate to the data maintained within mapped relationship data 138 (e.g., filtering account data based on account activity, or generating a moving average of a feature value, etc.).

In some instances, and upon execution by the one or more processors of computing system 130 (e.g., via corresponding ones of the distributed computing components), query generation engine 160 may perform any of the exemplary processes described herein to obtain elements of section data identifying and characterizing one or more feature selected by analyst 101 (e.g., based on input provisioned to analyst device 102 based on portions of the web-based GUI of the analytics feature store). Based on portions of mapped relationship data 138 (e.g., the mapped data tables and relationship data described herein) and of feature catalog store 140, executed query generation engine 160 may perform any of the exemplary processes described herein to generate elements of initial query code that, upon execution, join together subsets of the mapped data tables associated with the selected features, apply the temporal filter described herein, and generate a feature data table that includes each of the selected features. As described herein, the elements of initial query code may be structured in a Python™, in a structured query language (SQL) format, or in any additional, or alternate, appropriate format.

Further, a large-language module (LLM) module 162 of executed query generation engine 160 may perform any of the exemplary processes described herein to apply a trained, large-language model to the elements of initial query code, and to generate one or more additional elements of query code, e.g., elements of generative code, based on the application of the trained, large-language model to the elements of initial query code. As described herein, the large-language model may include, but is not limited to, a pre-trained generative transformer, such as a GPT 3.5 or GPT 4 process (e.g., a ChatGPT process), and the elements of generative code may, for example, apply one or more customized, analyst-and use-case-specific manipulations or filters to the features generated by the elements of initial query code (e.g., one or more additional temporal filters or temporal aggregations, other manipulations, etc.).

As described herein, a web-based interactive computational environment established and maintained at analyst device 102, such as a Jupyter™ notebook or a Databricks™ notebook, may access elements of the initial query code and/or the elements of generative code and execute the initial query code and/or the elements of generative code and generate a feature table that includes the selected features. In some instances, upon execution by the one or more processors of computing system 130, validation engine 164 may perform operations that, based on the execution of the initial query code and/or the elements of generative code, generate elements of validation data characterizing the generation of the feature table, such as, but not limited to, data frames characterizing a number of zero attributions of each of the features, and store the elements of validation data within the one or more tangible, non-transitory memories of computing system 130, e.g., within a corresponding portion of validation data store 144.

Further, and using any of the exemplary processes described herein, analyst device 102 may provide, to computing system 130, elements of feedback data that requests the addition of a particular extracted or derived feature, or of a particular filter, into the analytical feature store. Based on corresponding elements of the feedback data, a feedback engine 166 executed by the one or more processors of computing system 130 may process the feedback data and adjudicate the request to add the particular extracted or derived feature, or the particular filter, into the feature catalog store 140 based on one or more internal adjudication processes, e.g., that ensure robust features and filters within the analytical feature store.

### B. Exemplary Processes for Feature Generation and Management Within Interactive, Web-Based Computing Environments

In some instances, data integration engine 148 may, upon execution by the one or more processors of computing system 130 may cause computing system 130 to establish a secure, programmatic channel of communications with one or more of source systems 110 (e.g., source systems 110A and 110B) across network 120, and to perform operations that obtain elements of interaction data maintained by the one or more of source systems 110, and that to store the obtained elements of interaction data as source data tables within an accessible data repository (e.g., as source data tables within a portion of a distributed file system, such as a Hadoop distributed file system (HDFS)), in accordance with a predetermined, temporal schedule (e.g., on a daily basis, a weekly basis, a monthly basis, etc.) or on a continuous, streaming basis, e.g., as Data-as-a-Service (DaaS) data

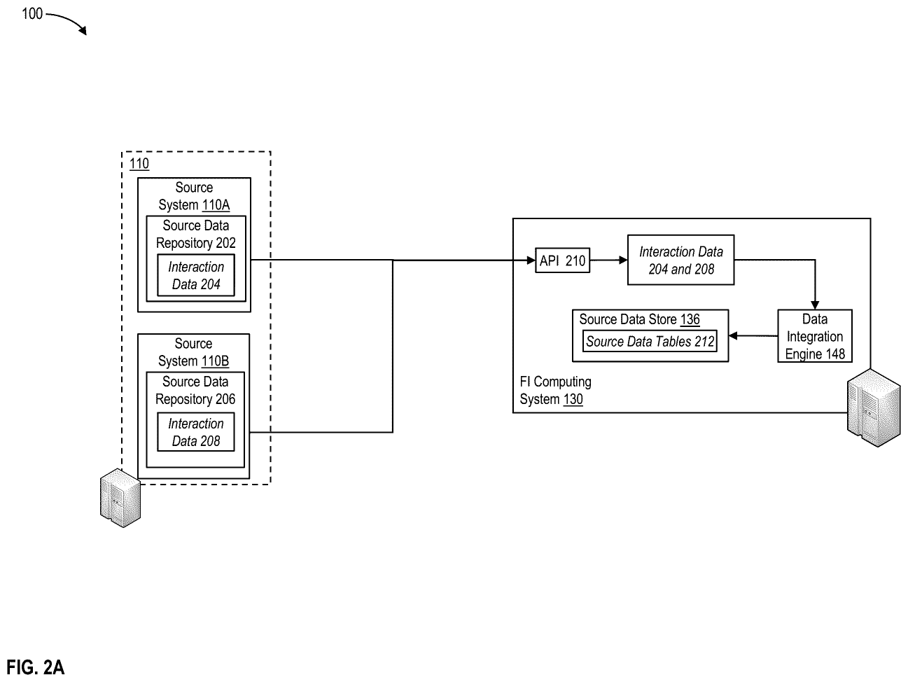

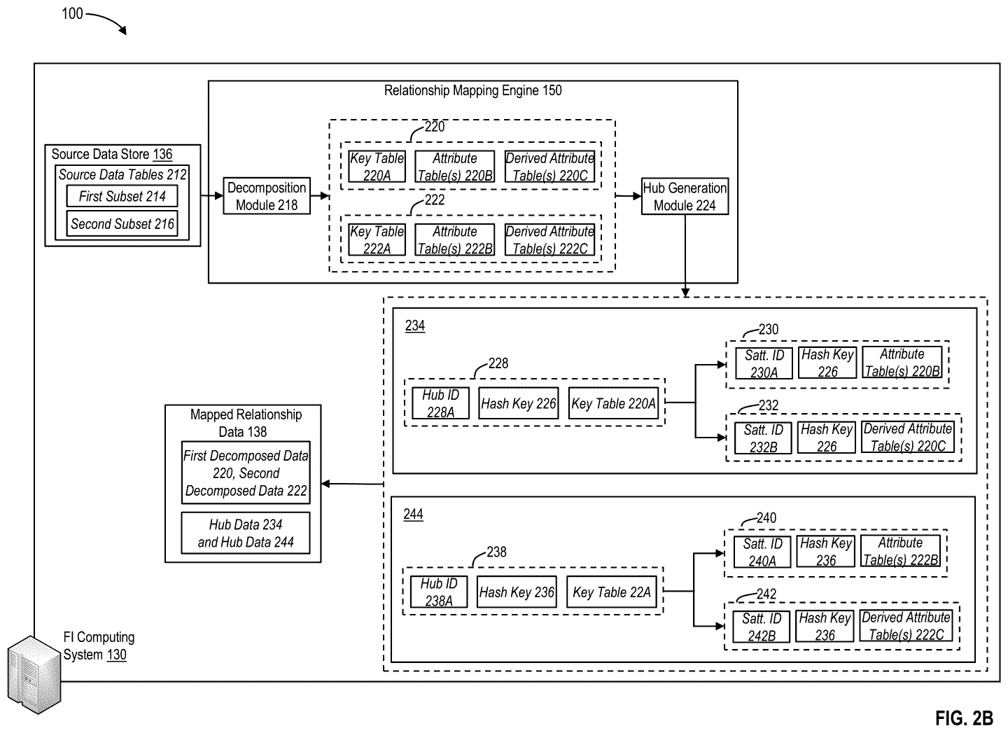

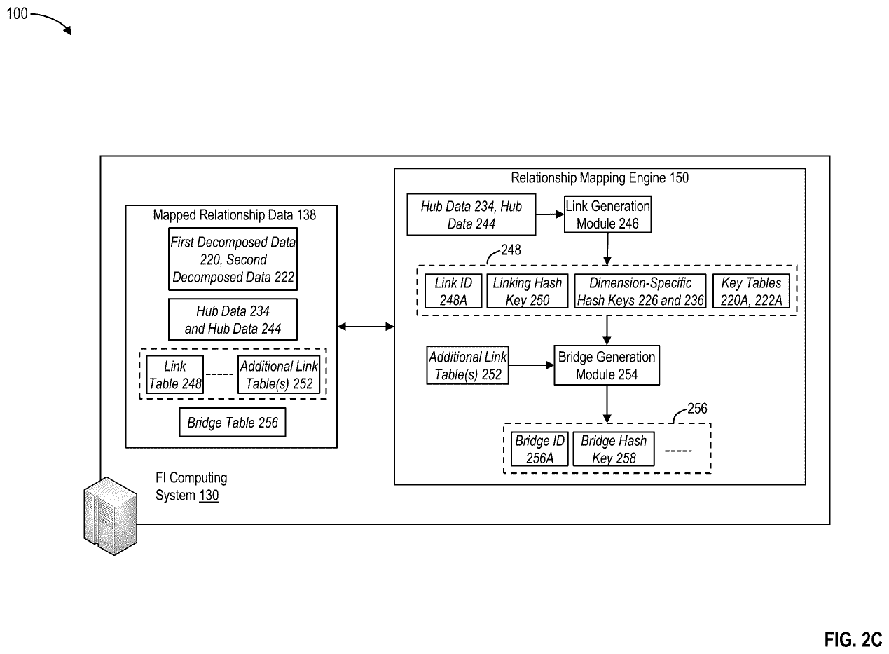

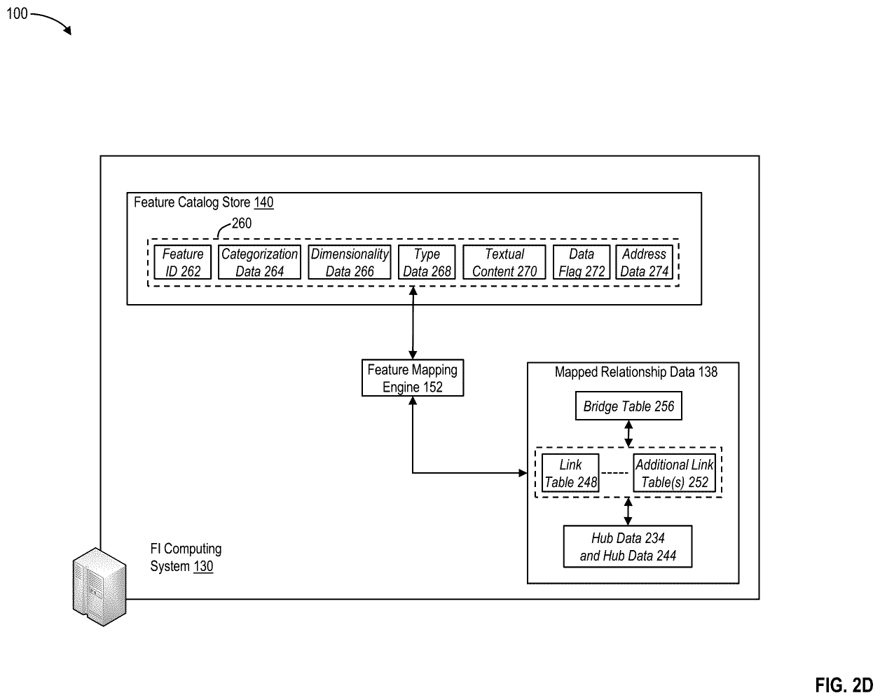

Referring to FIG. 2A, each of source systems 110 may maintain, within corresponding tangible, non-transitory memories, a data repository that includes elements of source data associated with, and characterizing, customers of the organization (such as the financial institution, described herein), interactions between these customers and the organization, such as, but not limited to, the financial institution described herein. In some instances, source system 110A may be associated with or operated by the organization and may maintain, within the one or more tangible, non-transitory memories, a source data repository 202 that includes interaction data 204 associated with, and characterizing, the customers of the organization. For example, interaction data 204 may include, but is not limited to, elements of profile data, account data, and transaction data that identify and characterize corresponding ones of the customers of the organization, and interaction data 204 may maintain the elements of profile account, and transaction data within corresponding data tables.

By way of example, and for a particular one of the customers, the data tables of the profile data may maintain, among other things, one or more unique customer identifiers (e.g., an alphanumeric character string, such as a login credential, a customer name, etc.), residence data (e.g., a street address, a postal code, one or more elements of global positioning system (GPS) data, etc.), other elements of contact data associated with the particular customer (e.g., a mobile number, an email address, etc.). Further, the account data may also include a plurality of data tables that identify and characterize one or more financial products or financial instruments issued by the financial institution to corresponding ones of the customers, such as, but not limited to, savings accounts, deposit accounts, or secured or unsecured credit products (e.g., credit card accounts or lines-of-credit) provisioned to a corresponding customer by the financial institution. For example, the data tables of the account data may maintain, for each of the financial products or instruments issued to corresponding ones of the customers, one or more identifiers of the financial product or instrument (e.g., an account number, expiration data, card-security-code, etc.), one or more unique customer identifiers (e.g., an alphanumeric character string, such as a login credential, a customer name, etc.), information identifying a product type that characterizes the financial product or instrument, and additional information characterizing a balance or current status of the financial product or instrument (e.g., payment due dates or amounts, delinquent accounts statuses, etc.).

The transaction data may include data tables that identify, and characterize, one or more initiated, settled, or cleared transactions involving respective ones of the customers and corresponding ones of the financial products or instruments. For instance, and for a particular transaction involving a corresponding customer and corresponding financial product or instrument, the data tables of the transaction data may include, but are limited to, a customer identifier associated with the corresponding customer (e.g., the alphanumeric character string described herein, etc.), a counterparty identifier associated with a counterparty to the particular transaction (e.g., a counterparty name, a counterparty identifier, etc.); an identifier of a financial product or instrument involved in the particular transaction and held by the corresponding customer (e.g., a portion of a tokenized or actual account number, bank routing number, an expiration date, a card security code, etc.), and values of one or more parameters that characterize the particular transaction. In some instances, the transaction parameters may include, but are not limited, to a transaction amount, associated with the particular transaction, a transaction date or time, an identifier of one or more products or services involved in the purchase transaction (e.g., a product name, etc.), or additional counterparty information.

Source system 110B may be associated with, or operated by, one or more judicial, regulatory, governmental, or reporting entities external to, and unrelated to, the organization, and source system 110B may maintain, within the corresponding one or more tangible, non-transitory memories, a source data repository 206 that includes one or more elements of interaction data 208. By way of example, source system 110C may be associated with, or operated by, a reporting entity, such as a credit bureau, and interaction data 208 may include elements of reporting data that identifies and characterizes corresponding customers of the organization, such as elements of credit-bureau data characterizing the customers of the financial institution. Further, and as described herein, interaction data 114 may maintain the elements of reporting data within corresponding data tables. The disclosed embodiments are, however, not limited to these exemplary elements of interaction data 204 and 208, and in other instances, interaction data 204 and 208 may include any additional or alternate elements of data that identify and characterize the customers of the organization (e.g., the financial institution described herein) and interactions between these customers and the organization, between these customers and unrelated, third-party organizations.

As described herein, computing system 130 may perform operations that establish and maintain one or more centralized data repositories within a corresponding ones of the tangible, non-transitory memories. For example, as illustrated in FIG. 2A, computing system 130 may establish source data store 136, which maintains, among other things, elements of the profile, account, transaction, and/or reporting data associated with one or more of the customers of the organization, which may be ingested by computing system 130 (e.g., from one or more of source systems 110) using any of the exemplary processes described herein.

For instance, computing system 130 may execute one or more application programs, elements of code, or code modules, such as data integration engine 148, that, in conjunction with the corresponding communications interface, cause computing system 130 to establish a secure, programmatic channel of communication with each of source systems 110 (including source systems 110A and 110B) across communications network 120, and to perform operations that access and obtain all, or a selected portion, of the elements of profile, account, transaction, and/or reporting data maintained by corresponding ones of source systems 110. As illustrated in FIG. 2A, source system 110A may perform operations that obtain all, or a selected portion, of interaction data 204 from source data repository 202, and transmit the obtained portions of interaction data 204 across communications network 120 to computing system 130. Further, source system 110B may also perform operations that obtain all, or a selected portion, of interaction data 208 from source data repository 206, and transmit the obtained portions of interaction data 208 across communications network 120 to computing system 130.

A programmatic interface established and maintained by computing system 130, such as application programming interface (API) 210 associated with executed data integration engine 148, may receive the portions of interaction data 204 and 208, and as illustrated in FIG. 2A, API 210 may route the portions of interaction data 204 and 208 to executed data integration engine 148. In some instances, the portions of interaction data 204 and 208 may be encrypted, and executed data integration engine 148 may perform operations that decrypt each of the encrypted portions of interaction data 204 and 208 using a corresponding decryption key, e.g., a private cryptographic key associated with computing system 130.

Executed data integration engine 148 may also perform operations that store the portions of interaction data 204 and interaction data 208 as corresponding ones of source data tables within source data store 136, e.g., as source data tables 212. In some instances, executed data integration engine 148 may also perform operations, described herein and not illustrated in FIG. 2A, that apply one or more data pre-processing operations, and additionally or alternatively, one or more extract, transform, or load (ETL) operations, to corresponding ones of ingested source data tables 212 in accordance with a modular data format, such as, but not limited to, a Data Vault 2.0™ protocol.

Further, although not illustrated in FIG. 2A, source data store 136 may also store one or more additional source data tables associated with corresponding ones of the customers of the organization, which may be ingested by executed data integration engine 148 during one or more prior temporal intervals. In some instances, executed data integration engine 148 may perform one or more synchronization operations (not illustrated in FIG. 1A), that merge one or more of source data tables 212 with the previously ingested source data tables, and that eliminate any duplicate tables existing among the one or more of source data tables 212 with the previously ingested source data tables (e.g., through an invocation of an appropriate Java-based SQL “merge” command).

Referring to FIG. 2B, and upon execution by the one or more processors of computing system 130, relationship mapping engine 150 executed by the one or more processors of computing system 130 may access each, or a selected subset, of source data tables 212, and based on an application of one or more dynamic mapping operations consistent with the modular data format (e.g., the Data Vault 2.0™ protocol) to the accessed ones of source data tables 212, executed relationship mapping engine 150 may perform operations that dynamically map associations and relationships between corresponding ones of source data tables 212, and additionally, or alternatively, between rows and columns of the corresponding ones of source data tables 212. In some instances, executed relationship mapping engine 150 may perform operations that store the mapped data tables (e.g., the business keys, associated attribute tables, and associated derived attribute tables, as described herein), and data characterizing the mapped associations and relationships, within a portion of the one or more tangible, non-transitory memories of computing system 130, e.g., as mapped relationship data 138.

By way of example, the elements of interaction data maintained within each of source data tables 212 may be associated with, and characterized by, a corresponding dimension, such as, but not limited to, an entity dimension associated with corresponding customers of the organization or accounts held by these customers and an event dimension associated with corresponding “events” involving the customers of the organization. In some instances, the elements of mapped relationship data 138 may indicate the dimension (e.g., the entity or event dimension, etc.) associated with each of source data tables 212. Additionally, in some instances, the elements of mapped relationship data 138 may also include data that parameterizes a subset of source data tables 212 associated with the event dimension in accordance with an observation unit (e.g., unique financial transactions involving accounts held by the corresponding customers, unique transactions involving holdings of the corresponding customers of the financial institution, or unique digital interactions between the corresponding customers and the organization, such as the financial institution) and further, in accordance with an observation-unit-specific granularity (e.g., an account granularity or an account and customer granularity).

By way of example, for an observational unit of the event dimension associated with the unique financial transactions and the account granularity, each row of the subset of source data tables 212 may characterize and represent a unique financial transactions linked to a specific account of a customer, such as, but not limited to, buy and sell trades, contributions, deposits, transfers, withdrawal, payments, and internal transfers. Further, for the event dimension, and corresponding combinations of the parameterized observation units and granularities, the elements of mapped relationship data 138 may also maintain identifiers of the business keys of the corresponding subset of source data tables 212.

The elements of mapped relationship data 138 may also parameterize a subset of mapped relationship data 138 associated with the entity dimension in accordance with an observation unit (e.g., rows of the subset of mapped relationship data 138 associated with a corresponding customer, a corresponding account held by that customer, a corresponding advisor, or a corresponding household, etc.) and a corresponding, feature-specific aggregation method (e.g., split or no split). For example, for a split aggregation method, any numerical account feature extracted from, or derived from, the subset of source data tables 212 may be aggregated at a customer by multiplying the corresponding feature by a split percentage and summing the result across all accounts held by that customer. Further, for the entity dimension, and corresponding combinations of the parameterized observation units and aggregation methods, the elements of mapped relationship data 138 may also maintain identifiers of the business keys of the corresponding subset of source data tables 212.

In some instances, executed relationship mapping engine 150 may perform operations that identify subsets of source data tables 212 associated with corresponding one of the entity and event dimensions, and that consolidate each of the dimension-specific subsets of the source data tables 212 into a corresponding, dimension-specific consolidated data table, which executed relationship mapping engine 150 may store within mapped relationship data 138. For example, executed relationship mapping engine 150 may identify a first subset 214 of source data tables 212 associated with a customer dimension (e.g., a corresponding “entity” dimension), and a second subset 216 of source data tables 212 associated with a corresponding transaction dimension (e.g., a corresponding one of the “event” dimensions associated with accounts held by the customers).

In some instances, each of first subset 214 and second subset 216 of source data tables 112 (and additional, or alternate, dimension-specific subsets of source data tables 212), may be associated with, and may include, one or more business keys that identify the corresponding, dimension-specific observation unit. By way of example, first subset 214 of source data tables 112 may be associated with an entity dimension associated with corresponding customers of the organization (e.g., the customer dimension described herein), and each of first subset 214 of source data tables 112 may include one or more common business keys that identify unique the customers across corresponding temporal intervals. Examples of these dimension-specific business keys may include a customer identifier (e.g., a unique, alphanumeric identifier of corresponding ones of the customers) and a process date (e.g., a date upon which computing system 130 ingested to corresponding one of source data tables 212).

As described herein, second subset 216 of source data tables 112 may be associated with an event dimension associated with financial transactions involving corresponding customers of the organization (e.g., the transaction dimension), and each of second subset 216 of source data tables 112 may include one or more common business keys that identify unique the financial transactions across corresponding temporal intervals. Examples of these dimension-specific business keys may include, but are not limited to, a transaction identifier (e.g., a unique, alphanumeric identifier of corresponding ones of the transactions), an account identifier (e.g., an alphanumeric identifier, such as an account number, of an account involved in corresponding ones of the transactions), and a process date (e.g., a date upon which computing system 130 ingested to corresponding one of source data tables 212). The disclosed embodiments are, however, not limited to these exemplary business keys, and in other instances, the first subset 214, second subset 216, and any additional or alternate subset of source data tables 212 may include additional, or alternate, business keys that characterize the data maintained within corresponding ones of the source data tables and that would be appropriate to the corresponding dimension.

Further, and in additional to the common business keys described herein, each of the source data tables of first subset 214 and second subset 216 may also maintain values of one or more attributes that identify and characterize corresponding customers of the organization (e.g., within first subset 214 associated with the customer dimension) and corresponding financial transactions involving these customers (e.g., within second subset 216 associated with the transaction dimension). By way of example, these attribute values may correspond to native, or raw and unprocessed, attribute values maintained within the elements of interaction data (e.g., interaction data 204 and 208) ingested by executed data integration engine 148, or may correspond to derived attribute values generated by executed data integration engine 148 based on an application of any of the exemplary pre-processing operations described herein to the ingested elements of interaction data.

Referring back to FIG. 2B, a decomposition module 218 of executed relationship mapping engine 150 may access each of the dimension-specific subsets of source data tables 212, e.g., first subset 214 and second subset 216, and may perform operations that consolidate each of the dimension-specific subsets of source data tables 212 into a corresponding, dimension-specific consolidated data table. Executed decomposition engine 218 may also perform operations that decompose each of the dimension-specific consolidated data table into a corresponding key table that maintains the business keys, one or more attribute tables that maintain respective ones of the native, or raw, attributes of the corresponding, dimension-specific consolidated data table, and one or more derived attribute tables that maintain respective ones of the derived attributes of the corresponding, dimension-specific consolidated data table.

For example, executed decomposition module 218 may perform operations that consolidate the source data tables of first subset 214 into a first consolidated data table that maintains the common business keys and the native and derived attributes, and that decompose the first consolidated data table associated with the customer dimension into a key table 220A that maintains the dimension-specific business keys associated with first subset 214 (e.g., the customer identifier and the process date described herein), one or more attribute tables 220B that maintain corresponding ones of the native attributes maintained within the first consolidated data table, and one or more derived attribute tables 220C that maintain corresponding ones of the derived attributes maintained within the first consolidated data table. In some instances, executed decomposition module 218 may package key table 220A, and each of attribute tables 220B and derived attribute tables 220C, into corresponding elements of first decomposed data 220, which executed decomposition module 218 may store within a corresponding potion of mapped relationship data 138 (not illustrated in FIG. 2B).

Executed decomposition module 218 may also perform operations that consolidate the source data tables of second subset 216 into a second consolidated data table that maintains the common business keys and the native and derived attributes. Further, executed decomposition engine 218 may perform operations, described herein, hat decompose the second consolidated data table associated with the customer dimension into a key table 222A that maintains the dimension-specific business keys associated with second subset 216 (e.g., the transaction identifier, the account identifier, and the process date described herein), one or more attribute tables 222B that maintain corresponding ones of the native attributes maintained within the second consolidated data table, and one or more derived attribute tables 222C that maintain corresponding ones of the derived attributes maintained within the second consolidated data table.

In some instances, executed decomposition module 218 may package key table 222A, and each of attribute tables 222B and derived attribute tables 222C, into corresponding elements of second decomposed data 222, which executed decomposition module 218 may store within a corresponding portion of mapped relationship data 138 (not illustrated in FIG. 2B). Additionally, although not illustrated in FIG. 2B, executed decomposition module 218 may also perform any of these exemplary processes to generate an additional, dimension-specific consolidated data table associated with each additional, or alternate, dimension-specific subset of source data tables 212, and to decompose each of the additional, dimension-specific consolidated data tables into a corresponding elements of decomposed data, e.g., a corresponding key table, one or more corresponding attribute tables, and one or more corresponding, derived attribute tables.

Referring back to FIG. 2B, executed decomposition module 218 may provide first decomposed data 220, which includes key table 220A, attribute tables 220B and derived attribute tables 220C, and second decomposed data 222, which includes key table 222A, and each of attribute tables 222B and derived attribute tables 222C, as input to a hub generation module 224 of executed relationship mapping engine 150 (e.g., along with the elements of decomposed data associated with each additional, or alternate, dimension-specific subset of source data tables 212). In some instances, executed hub generation module 224 may access the elements of first decomposed data 220 and second decomposed data 222 (and each additional, or alternate, elements of decomposed data), and perform any of the exemplary process described herein to generate a dimension-specific hub table for each of the elements of decomposed data (e.g., first decomposed data 220 and second decomposed data 222, etc.) that associate each of the corresponding business keys with one or more attribute-specific satellite tables in accordance with a modular data format, such as, but not limited to, a Data Vault 2.0™ protocol.

Executed hub generation module 224 may access first decomposed data 220, which includes key table 220A, attribute tables 220B, and derived attribute tables 220C, and may perform operations that generate a corresponding, dimension-specific hash key 226 associated with the business keys maintained within key table 220A. Dimension-specific hash key 226 may, for example, correspond to a hash value, which executed hub generation module 224 may generate based on an application of a corresponding hash process to one or more of the business keys within key table 220A, or additionally, or alternatively, to corresponding portions of attribute tables 220B and derived attribute tables 220C, and examples of these may include, but are not limited to, an SHA-2 algorithm or an SHA-3 algorithm.

Further, executed hub generation module 224 may perform operations, described herein, that generate a dimension-specific hub table 228 that includes a unique, dimension-specific hub identifier 228A, hash key 226, and key table 220A, and further, that generate a corresponding satellite table associated with hub table 228 for each of attribute tables 220B and derived attribute tables 220C. For example, as illustrated in FIG. 2B, executed hub generation module 224 may generate a corresponding one of satellite tables 230 for each of attribute tables 220B, and the corresponding one of satellite tables 230 may include, but is not limited to, a corresponding table identifier (e.g., satellite table identifier 230A), hash key 226, and the corresponding one of attribute tables 220B.

Executed hub generation module 224 may also perform operations that generate a corresponding one of derived satellite tables 232 for each of derived attribute tables 220C, and the corresponding one of derived satellite tables 232 may include, but is not limited to, a corresponding table identifier (e.g., derived satellite table identifier 232A), hash key 226, and the corresponding one of derived attribute tables 220B. In some instances, the maintenance of hash key 226 within hub table 228, and within each of satellite tables 230 and derived satellite tables 232 may associate each of satellite tables 230 and derived satellite tables 232 with hub table 228, and a combination of hash key 226 and a satellite table identifier (satellite table identifier 230A and satellite table identifier 232A) may represent a unique address of the corresponding attribute table or derived attribute table within the modular data format described herein (e.g., the Data Vault 2.0™ protocol), which facilitates a retrieval and/or manipulation of the corresponding attribute table or derived attribute table using any of the exemplary processes described herein.

Additionally, as illustrated in FIG. 2B, hub generation module 224 may also access second decomposed data 222, which includes key table 222A, attribute tables 222B and derived attribute tables 222B (e.g., associated with the transaction dimension described herein), and may perform any of the exemplary processes described herein to generate a corresponding, dimension-specific hash key 236 associated with the business keys maintained within key table 222A. Executed hub generation module 224 may perform operations, described herein, that generate a dimension-specific hub table 238 that includes a unique, dimension-specific hub identifier 238A, hash key 236, and business keys 222A, and further, that generate a corresponding satellite table associated with hub table 238 for each of attribute tables 222B and derived attribute tables 222C.

For example, as illustrated in FIG. 2B, executed hub generation module 224 may generate a corresponding one of satellite tables 240 for each of attribute tables 222B, and the corresponding one of satellite tables 240 may include, but is not limited to, a corresponding table identifier (e.g., satellite table identifier 240A), hash key 236, and the corresponding one of attribute tables 222B. Further, executed hub generation module 224 may also perform operations that generate a corresponding one of derived satellite tables 242 for each of derived attribute tables 222C, and the corresponding one of derived satellite tables 242 may include, but is not limited to, a corresponding table identifier (e.g., derived satellite table identifier 242A), hash key 236, and the corresponding one of derived attribute tables 222B. As described herein, the maintenance of hash key 236 within hub table 238, and within each of satellite tables 240 and derived satellite tables 242 may associate each of satellite tables 240 and derived satellite tables 242 with hub table 238, and a combination of hash key 236 and a satellite table identifier (satellite table identifier 240A and satellite table identifier 242B) may represent a unique address of the corresponding attribute table or derived attribute table within the modular data format described herein (e.g., the Data Vault 2.0™ protocol), which facilitates a retrieval and/or manipulation of the corresponding attribute table or derived attribute table using any of the exemplary processes described herein.

In some instances, executed hub generation module 224 may package hub table 228, and associated satellite tables 230 and derived satellite tables 232, into corresponding portions of dimension-specific hub data 234, which may be associated with the customer dimension described herein, and may package hub table 238, and associated satellite tables 240 and derived satellite tables 242, into corresponding portions of dimension-specific hub data 244, which may be associated with the transaction dimension described herein. Executed hub generation module 224 may store the elements of hub data 234 and 244 within the one or more tangible, non-transitory memories of computing system 130, e.g., within a portion of mapped relationship data 138. Further, although not illustrated in FIG. 2B, executed hub generation module 224 may also perform any of the exemplary processes described here to generate elements of hub data associated with each additional, or alternate, dimension-specific subset of source data tables 212 and corresponding elements of decomposed data.

Referring to FIG. 2C, executed hub generation module 224 may provide the elements of hub data characterizing each of the generated, dimension-specific hub tables, and associated satellite tables and derived satellite tables, such as, but not limited to the elements of hub data 234 and 244, as inputs to a link generation module 246 of executed relationship mapping engine 150. In some instances, executed link generation module 246 may perform operations, described herein, that generate one or more link tables that associated corresponding pairs of the generated, dimension-specific hub tables, such as, but not limited to, hub table 228 associated with the customer dimension and hub table 238 associated with the transaction dimension in accordance with the modular data format, e.g., the Data Vault 2.0™ protocol. Each of the generated link tables may be associated with corresponding table identifier and with a corresponding hash key, and may include, and inherit, the business keys and hash keys maintained within corresponding ones of the linked hub tables. In some instances, the maintenance of the link-specific hash key within the link table in conjunction with the hash keys of the linked hub tables may maintain the unique addressing of the attribute tables or derived attribute table within the modular data format described herein (e.g., the Data Vault 2.0™ protocol), which facilitates a retrieval and/or manipulation of the corresponding attribute table or derived attribute table using any of the exemplary processes described herein.

For example, executed link generation module 246 may receive the elements of hub data 234, which includes hub table 228 and associated satellite tables 230 and derived satellite tables 232, and the elements of hub data 244, which include hub table 238 and associated satellite tables 240 and derived satellite tables 242. In some instances, executed link generation module 246 may perform operations that a link table 248 that links together, and associates, each of dimension-specific hub tables 228 and 238, and further, each of dimension-specific satellite tables 230 and 240 and dimension-specific, derived satellite tables 232 and 242. In some instances, link table 248 may include a unique link identifier 248A (e.g., alphanumeric identifier, such as a name), each of the dimension-specific hash keys maintained within hub tables 228 and 238 (e.g., hash keys 226 and 236), and each of the business keys maintained within hub tables 228 and 238 (e.g., the dimension-specific business keys within key tables 220A and 222A).

Executed link generation module 246 may also perform operations that generate a corresponding, linking hash key 250 associated with linked hub tables 228 and 238 (and the corresponding, linked business keys maintained within key tables 220A and 222A), and that package linking hash key 250 within a corresponding portion of link table 248. Linking hash key 250 may, for example, correspond to a hash value, which executed link generation module 246 may generate based on an application of a corresponding hash process to one or more of the dimension-specific business keys within key tables 220A and 220B, or additionally, or alternatively, to corresponding portions of attribute tables 220B and derived attribute tables 220C, and examples of these hash processes may include, but are not limited to, an SHA-2 algorithm or an SHA-3 algorithm. Further, although not illustrated in FIG. 2C, executed link generation module 246 may also package, into corresponding portions of link table 248, one of more of the satellite tables or derived satellite tables associated with corresponding ones of hub table 228 (e.g., satellite table 230 and derived satellite table 232) and hub table 238 (e.g., satellite table 240 and derived satellite table 242).

In some instances, link generation module 246 may store link table 248 within the one or more tangible, non-transitory memories of computing system 130, e.g., within a portion of mapped relationship data 138 associated with hub data 234 and 244. Further, although not illustrated in FIG. 2C, executed link generation module 246 may perform any of the exemplary processes described herein to generate an additional link table that associates an additional, or alternate, one of the corresponding pairs of the generated, dimension-specific hub tables, and to store the additional link table within a corresponding portion of mapped relationship data 138, e.g., as one of additional data tables 352 associated with link table 248.

Further, as illustrated in FIG. 2C, executed link generation module 246 may provide link table 248 as an input to a bridge generation module 254 of executed relationship mapping engine 150. In some instances, executed bridge generation module 254 may receive link table 248, which links together and associates corresponding ones of the dimension-specific hub tables 228 and 238, and may access one or more of additional link tables 252, which link together additional, or alternate, pairs of dimension-specific hub tables, from the corresponding portion of mapped relationship data 138. Executed bridge generation module 254 may, for example, perform operations that generate a bridge table 256 that associates, and joins together, each link table 248 and each of additional link tables 252, and further, each of the satellite and derived satellite tables linked to the hub tables associated with these link tables, while maintaining the unique addressing of the corresponding attribute table or derived attribute table within the modular data format described herein (e.g., the Data Vault 2.0™ protocol), and facilitating the retrieval and/or manipulation of the corresponding attribute table or derived attribute table using any of the exemplary processes described herein.

For example, bridge table 256 may include a unique bridge identifier 256A (e.g., alphanumeric identifier, such as a name), each of the linking hash keys maintained within the corresponding link tables (e.g., linking hash key 250 of link table 250), each of the dimension-specific hash keys linked to, and associated with, corresponding ones of linking hash keys (e.g., dimension-specific hash keys 226 and 236 linked to, and associated with, linking hash key 250 within link table 250), and further, each of the business keys associated with, and linked to, these dimension-specific hash keys (e.g., the dimension-specific business keys maintained within key tables 220A and 222A, which may be associated with corresponding ones of dimension-specific hash keys 226 and 236). Further, although not illustrated in FIG. 2C, executed bridge generation module 254 may also package, into corresponding portions of bridge table 256, one of more of the satellite tables or derived satellite tables associated with corresponding ones of linked and associated hub tables and corresponding, dimension-specific hash keys (e.g., satellite table 230 and derived satellite table 232 associated with hub table 228, satellite table 240 and derived satellite table 242 associated with satellite table 230, etc.).

Executed bridge generation module 254 may also perform operations that generate a corresponding, bridge hash key 258 associated with now-associated (and bridged) link table 248 and additional link tables 252, and that package bridge hash key 258 within a corresponding portion of bridge table 256. Bridge hash key 258 may, for example, correspond to a hash value, which executed bridge generation module 254 may generate bridge hash key 258 based on an application of a corresponding hash process to elements of data maintained within bridge table 256, such as, but not limited to, the linking hash keys described herein, and examples of these hash processes may include, but are not limited to, an SHA-2 algorithm or an SHA-3 algorithm. In some instances, bridge generation module 254 may store bridge table 256 within the one or more tangible, non-transitory memories of computing system 130, e.g., within a portion of mapped relationship data 138 associated with link table 248 and additional link tables 252.

In some examples, and through a performance of one or more of the exemplary processes described herein, executed relationship mapping engine 150 may establish a “generative” database structure in accordance with the modular data format described herein (e.g., the Data Vault 2.0™ protocol) and based on the maintenance of hierarchical relationship between bridge table 256, each of the associated link tables, which link together corresponding dimension-specific hub tables (e.g., link table 248 and additional link tables 252), and the corresponding, dimension-specific hub tables, which link together pairs of dimension-specific satellite tables and derived satellite tables (e.g., hub table 228 and associated satellite table 230 and derived satellite table 232, hub table 238 and associated satellite table 240 and derived satellite table 242). Further, and through a maintenance of the unique addressing of each of the satellite tables (e.g., the attributed tables linked to corresponding hub tables) and derived satellite tables (the derived attributed tables linked to corresponding hub tables) within the generative database structure, the one or more processors of computing system 130 may perform any of the exemplary processes described herein to identify one or more database operations that facilitate a generation of, corresponding features identified and characterized within the data records of feature catalog store 140, and to generate operational data that specifies each of the identified database operations, e.g., an application of Java-based SQL “join” commands, such as appropriate “inner” or “outer” join command, to corresponding ones of attribute tables or derived attribute tables based on the unique identifier of the corresponding satellite or derived satellite table and the corresponding hash key, which may be maintained and preserved within the corresponding hub table, and through the corresponding link and bridge tables.

For example, referring to FIG. 2D, feature catalog store 140 may include data records that identify and characterize one or more feature that may be extracted or derived from corresponding ones of mapped data tables maintained within mapped relationship data 138. For example, and for a corresponding feature, feature catalog store 140 may maintain one or more data records 260, which may include a feature identifier 262 (e.g., an alphanumeric feature name, etc.), categorization data 264 identifying a feature category that includes the corresponding feature (e.g., an alphanumeric category name, etc.), dimensionality data 266 that characterizes a dimension associated with the corresponding feature (e.g., a corresponding event or entity dimension, etc.), type data 268 that characterizes a corresponding feature type (e.g., text-based, binary, categorical, or floating-point numerical, etc.), and textual content 270 that describes (e.g., in natural, human-readable language) the feature and a relationship of that feature to a corresponding customer, account, transactional, or interaction-specific characteristic or behavior of the a corresponding customer.

Further, in some instances, the one or more data records 260 may also include a data flag 272 indicating that the corresponding feature represents an extracted feature, or alternatively, a derived feature. By way of example, an extracted feature may be extracted from a corresponding one of the satellite tables (and corresponding attribute tables) described herein without further processing. Based on the indication that the corresponding feature represents the extracted feature, feature mapping engine 152 may perform operations, upon execution by the one or more processors of computing system 130, that determine a unique address of the corresponding satellite table (and corresponding attribute table) within mapped relationship data 138, and may perform operations that generate an element of address data 274 that includes the determined address. For example, the corresponding feature may be extracted from a corresponding one of attribute tables 220B maintained within satellite table 230, and executed feature mapping engine 152 may perform operations that obtain the identifier of the satellite table (e.g., satellite table identifier 230A) and hash key 226 of hub table 228, which be maintained within link table 250 and bridge table 256, and package the identifier of the satellite table and hash key 226 (and in some instances, linking hash key 250 of link table 248) within address data 274.

Alternatively, data flag 272 may indicate that the corresponding feature represents a derived feature, and executed feature mapping engine 152 may perform any of the exemplary processes described herein to determine a unique address of a corresponding derived satellite table (and corresponding attribute table) within mapped relationship data 138, and to package the determined address (e.g., the identifier of the derived satellite table and a hash key of the corresponding hash table, etc.) into the element of address data 274 associated with the corresponding feature. In other instances, the corresponding feature may represent a derived feature not present within any of the derived satellite tables maintained within mapped relationship data 138, and may be generated based on an application of one or more database operations (e.g., those described herein) to corresponding ones of the attributes maintained within the satellite tables and/or to corresponding ones of the derived attributes maintained with the derived satellite tables.

Executed feature mapping engine 152 may, for example, perform any of the exemplary processes described herein to determine a unique address of each of the satellite tables and/or derived satellite tables subject to the one or more database operations, and to package the determined addresses, along with operation data characterizing the one or more database operations associated with the determined addresses, into the element of address data 274 associated with the corresponding feature. Further, although not illustrated in FIG. 2D, executed feature mapping engine 152 may perform any of the exemplary processes described herein to populate an element of address data (e.g., with a determined address of a satellite data table or derived satellite data table consistent with the module data format, and/or data specifying one or more database operations, etc.) for the feature associated with each additional, or alternate data record of feature catalog store 140.

As described herein, one or more processor(s) 104 of analyst device 102 may execute one or more one or more software applications, application engines, and other elements of code, such as web browser 106 capable of interacting with one or more web servers established programmatically by computing system 130. By way of example, and upon execution by the one or more processors, web browser 106 may interact programmatically with the one or more web servers of computing system 130 via a web-based interactive computational environment, such as a Juypter™ notebook or a Databricks™ notebook, and may request to a web-based graphical user interface (GUI) associated with feature catalog store 140. As described herein, the web-based GUI, when presented by display device 109A within the established, web-based, interactive computational environment, may facilitate an interaction of analyst 101 with the data records maintained within feature catalog store 140 and a selection of one or more of the features associated with corresponding dimensions (e.g., the event or entity dimensions described wherein), with corresponding, dimension-specific granularities or aggregation methods, and further with corresponding business keys maintained within mapped relationship data 138.

The presented, web-based GUI may, for example, prompt analyst 101 to provide input that searches for corresponding ones of the catalogued features based on, among other things, a feature name or based on an application of a trained, natural language process to portions of a structured or unstructured query and corresponding feature descriptions maintained by feature catalog store 140 (e.g., based on operations performed by NLP module 158 of feature search engine 156), and enable analyst 101 to provide input that specifies a temporal filter on the selected features (e.g., a range of dates), or one or more additional filters or data manipulations appropriate to the data maintained within mapped relationship data 138 (e.g., filtering account data based on account activity, or generating a moving average of a feature value, etc.).

By way of example, analyst 101 may provide, via input device 109B of analyst device 102, input to executed web browser 106 that requests access to the web-based GUI associated with feature catalog store 140, e.g., within the established, web-based interactive computational environment. The input may, for example, include a uniform resource locator (URL) of associated with the web-based GUI, and executed web browser 106 may process the URL, establish a programmatic channel of communication with computing system 130, and provision programmatically the request to access the web-based GUI to one or more application engines to computing system 130 across network 120.

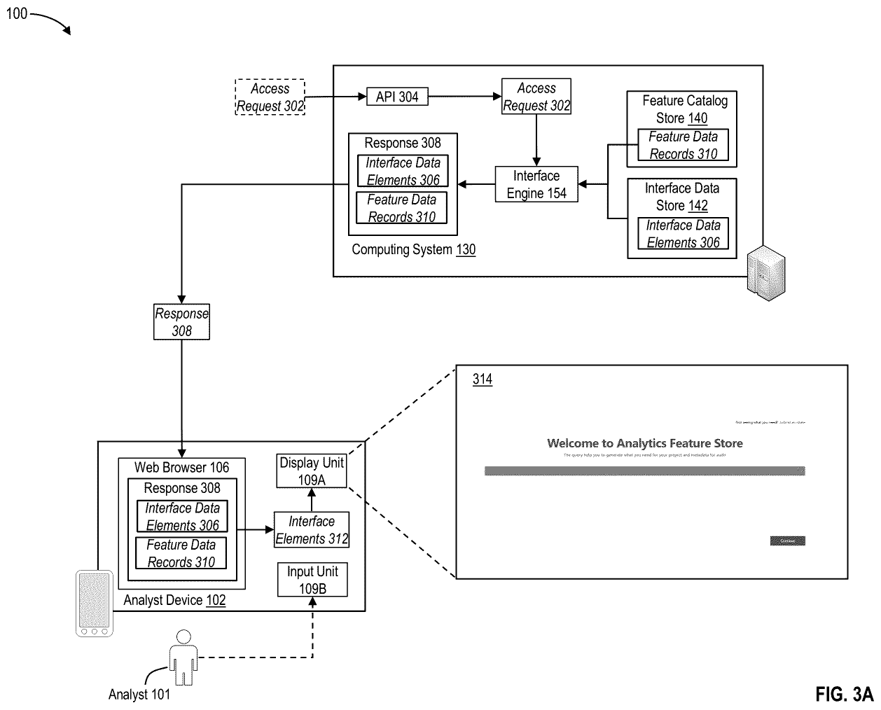

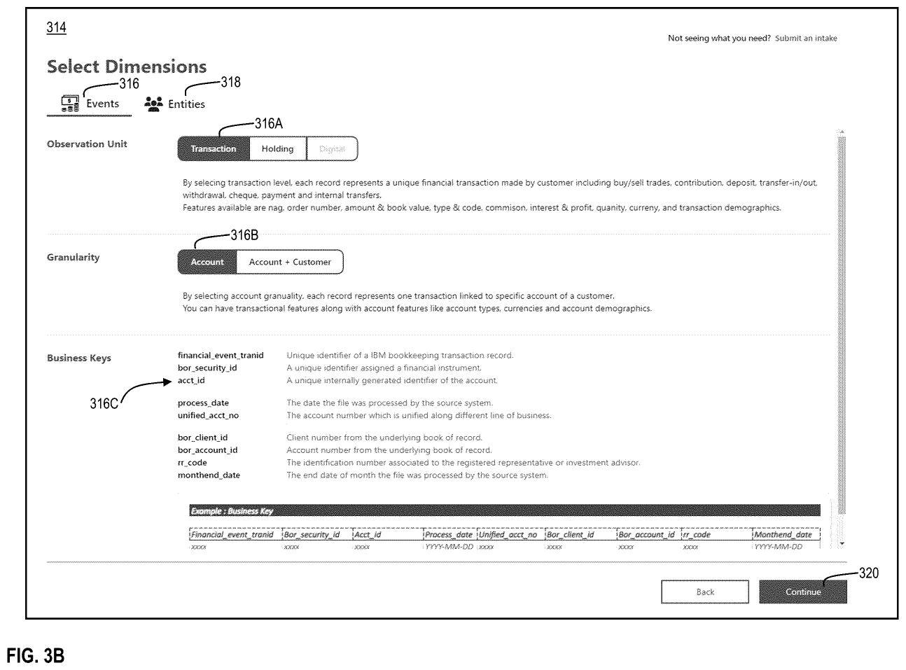

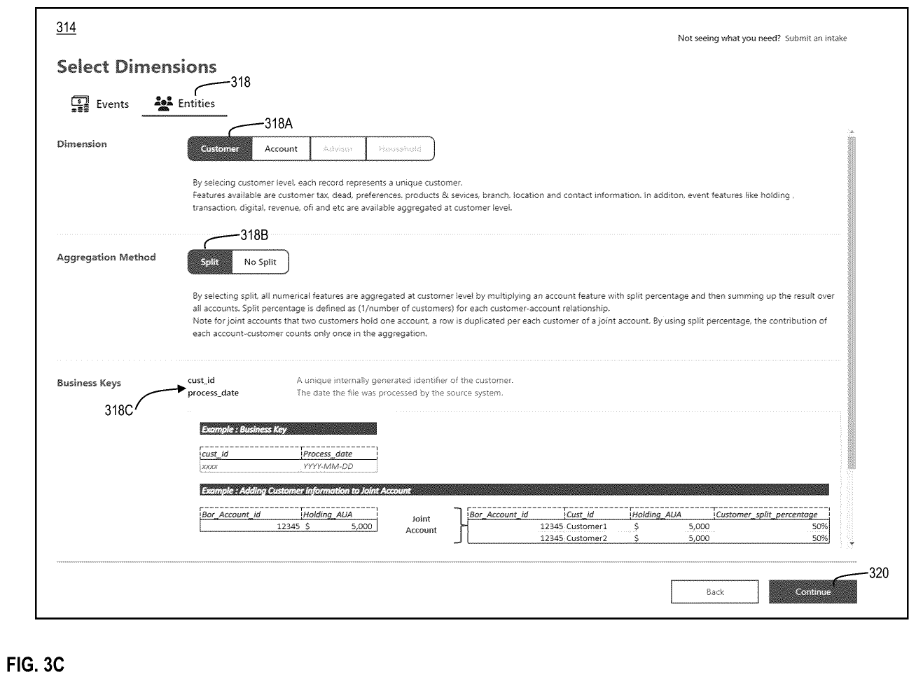

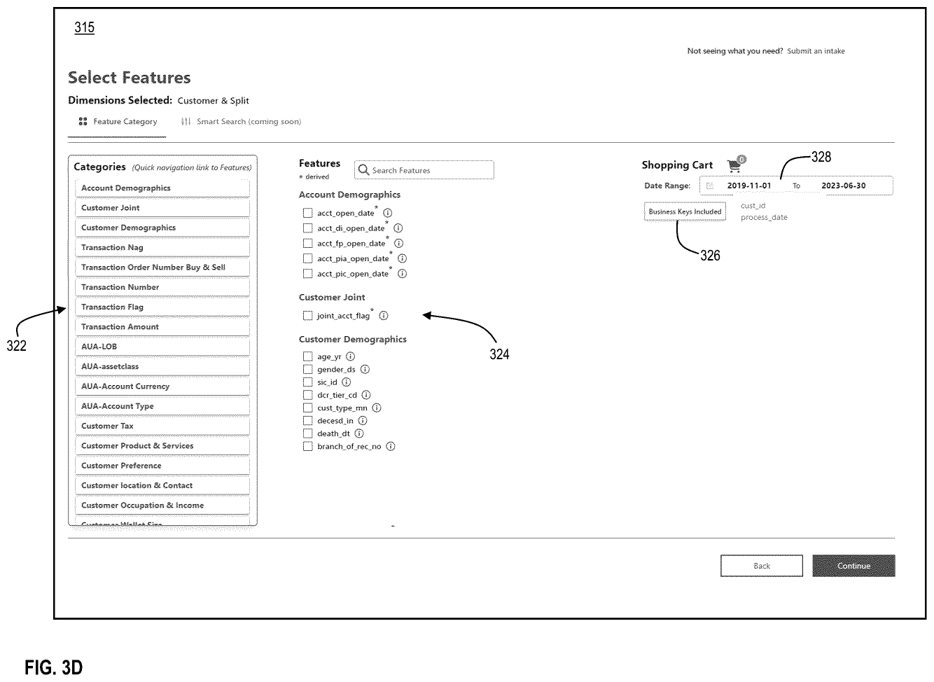

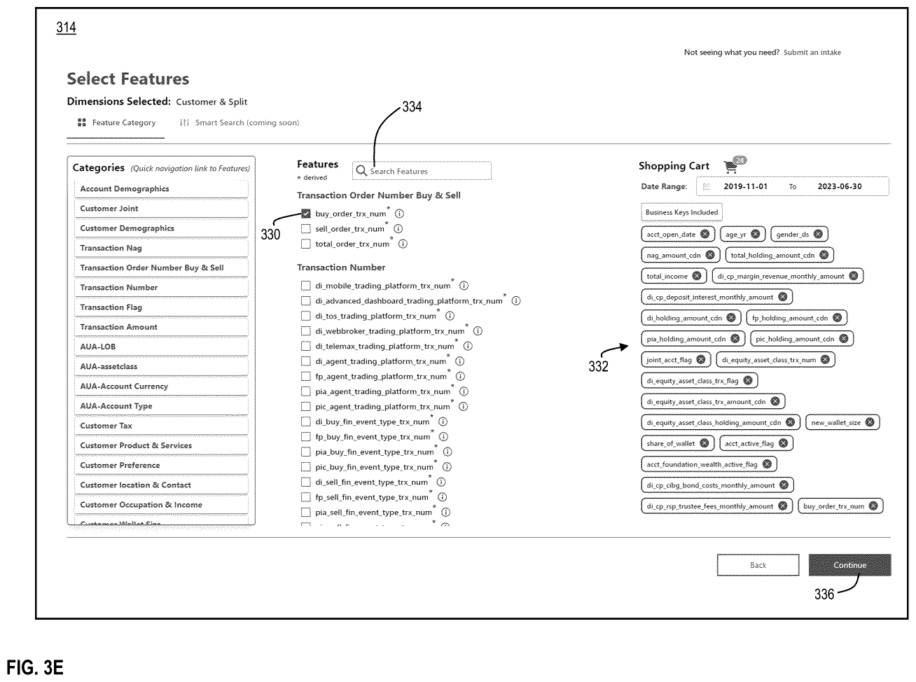

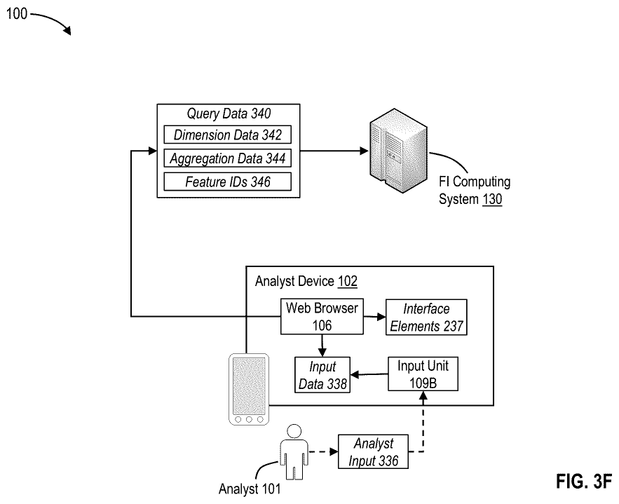

Referring to FIG. 3A, a programmatic interface associated with computing system 130, such as an application programming interface (API) 304 associated with the established, web-based interactive computational environment, may receive access request 302 and route access request 302 to interface engine 154, which may be executed by the one or more processors of computing system 130. In some instances, and upon receipt of access request 302, executed interface engine 154 may perform operations that access one or more elements of interface data 306 maintained within interface data store 142. The one or more elements of interface data 306 may, for example, identify and characterize one or more interface elements, and a layout of these interface elements, within an initial display screen of the web-based GUI (e.g., a “landing page”) and within subsequent display screens of the web-based GUI, and executed interface engine 154 may package the elements into a corresponding portion of a response 308 to the access request.

Further, in some instances, executed interface engine 154 may also access feature catalog store 140, and obtain feature data records 310 that identify and characterize one or more available features, which may be extracted or derived from the corresponding ones of the data tables maintained within mapped relationship data 138 using any of the exemplary processes described herein. As described herein, and for a corresponding feature, feature data records 310 may include, but are not limited to, a corresponding feature identifier (e.g., an alphanumeric feature name, etc.), elements of categorization data identifying a feature category that includes the corresponding feature (e.g., an alphanumeric category name, etc.), elements of dimensionality data that characterizes a dimension associated with the corresponding feature (e.g., a corresponding event or entity dimension, etc.), elements of type data that characterizes a corresponding feature type (e.g., text-based, binary, categorical, or floating-point numerical, etc.), and textual content that describes (e.g., in natural, human-readable language) the feature and a relationship of that feature to a corresponding customer, account, transactional, or interaction-specific characteristic or behavior of the a corresponding customer. As illustrated in FIG. 3A, executed interface engine 154 may package each of feature data records 310 into an additional portion of response 308, and may perform operations that cause computing system 130 to transmit response 308 across network 120 to analyst device 102, e.g., within the established, web-based interactive computational environment.

Executed web browser 106 may receive response 308, including the elements of interface data 306 and each of feature data records 310, and may perform operations that process the elements of interface data 306 and each of feature data records 310 and generate interface elements 312 associated with one or more display screens of the web-based GUI. In some instances, interface elements 312 may be populated with corresponding elements of interface data 306 and with portions of feature data records 310 (e.g., the feature identifiers, dimensions, and feature categories described herein), and executed web browser 106 may provision all, or a selected portion, of interface elements 312 as to display device 109A. As illustrated in FIG. 3A, display device 109A may render an initial portion of interface elements 312 for presentation within a corresponding digital interface 314, e.g., the “landing page” of the web-based GUI.

In some instances (not illustrated in FIG. 3A), analyst 101 may provide additional input to input device 109B that causes executed web browser 106 to present, via display device 109A, one or more additional display screens of the web-based GUI within digital interface 314. For example, as illustrated in FIG. 3B, executed web browser 106 may cause display device 109A to present, within digital interface 314, one or more additional pages of the web-based GUI, which may prompt analyst 101 to select one or more dimensions that characterize the available features, e.g., as specified within feature data records 310 for corresponding ones of the available features.

By way of example, analyst 101 may provide input to input device 109B that selects interface element 316 associated with the “event” dimension described herein, and executed web browser 106 may cause display device 109A to present, within digital interface 314, additional interface elements 316A that prompt analyst 101 to select an observation unit (e.g., (e.g., unique financial transactions involving accounts held by the corresponding customers of the organization, unique transactions involving holdings of the corresponding customers, or unique digital interactions between the corresponding customers and the organization, as described herein), additional interface elements 316B that prompt analyst 101 to select a corresponding granularity of the data tables maintained within mapped relationship data 138 and associated with the selected observation unit (e.g., an account granularity or an account and customer granularity). For instance, analyst 101 may provide additional input to input device 109B that selects interface element 316A associated with a transaction-specific observation unit, and that selects interface element 316C associated with an account-specific granularity, as described herein, and digital interface 314 may present additional interface elements 316C identifying one or more business keys associated with the selected dimension, observation unit, and/or granularity (e.g., as maintained within key table 222A of hub table 238). If analyst 101 were satisfied with these selections, analyst 101 may provide further input to input device 109B that select “Continue” icon 320, which causes executed web browser 106 to present, via display device 109A, one or more additional display screens of the web-based GUI, which may identify one or more available features, and corresponding feature categories, that are consistent with the selected dimension, observation unit, and/or granularity.

Alternatively, as illustrated in FIG. 3C, analyst 101 may provide input to input device 109B that selects an interface element 318 associated with an “entities” dimension, and the digital interface 314 may present additional interface elements that prompt analyst 101 to select an observation unit (e.g., a corresponding customer, a corresponding account held by that customer, a corresponding advisor, or a corresponding household, as described herein) and a corresponding, feature-specific aggregation method (e.g., split or no split). For example, analyst 101 may provide additional input to input device 109B that selects interface element 318A associated with a customer-specific observation unit, and that selects interface element 318B associated with a split-based aggregation method, as described herein, and digital interface 314 may present additional interface elements 318C identifying one or more business keys associated with the customer-specific observation unit and the split-based aggregation method (e.g., as maintained within key table 220A of hub table 228). Analyst 101 may provide further input to input device 109B that select “Continue” icon 320, which confirms the selection by analyst 101 of the customer-specific observation unit and the split-based aggregation method, and which causes executed web browser 106 to present, via display device 109A, one or more additional display screens of the web-based GUI, which may identify one or more available features, and corresponding feature categories, that are consistent with the customer-specific observation unit and the split-based aggregation method.

Referring to FIG. 3D, digital interface 314 may present additional interface elements 322 that identify a plurality of categories of features associated with, and consistent with, the selected customer-specific observation unit and split-based aggregation method. For example, upon selection of one or more of additional interface elements 322 (e.g., associated with the “Account Demographics,” Customer Joint,” “Customer Demographics” feature categories), executed web browser 106 may perform operations that cause display device 109A to present feature-specific interface elements 324 that identify subsets of the available features associated with corresponding ones of the selected feature categories, and with the selected customer-specific observation unit and split-based aggregation method. Further, and based on additional input to input device 109B that selects an interface element 326, digital interface 314 may present, to analyst 101, the business keys that are consistent with the customer-specific observation unit and the split-based aggregation method (e.g., the customer identifier and the process date described herein). Digital interface 314 may also include additional interface 328 that enable analyst 101 to specify, as a temporal filter, a range of dates, e.g., Nov. 1, 2019, through Jun. 20, 2023.

As illustrated in FIG. 3E, and to select one or more of the available features for inclusion within a corresponding feature query, analyst 101 may provide additional input to input device 109B that selects an checkbox 214A, which indicates a selection of derived feature “buy_order_trx_num,” and digital interface 314 may present an interface element confirming the selection of derived feature “buy_order_trx_num” within a portion 332 of digital interface 314 associated with a “shopping cart” of selected features (e.g., along with additional interface elements characterizing additional, or alternate, selections of additional, or alternate, features consistent with the customer-specific observation unit and the split-based aggregation method).

Further, digital interface 314 may also include text box 334, which enables analyst 101 to specify a particular feature identifier (or portion of a particular feature identifier), which may be transmitted to computing system 130 via executed web browser 106. In some instances, feature search engine 156 may, upon execution by the one or more processors of computing system 130, receive the specified query, parse the feature identifiers maintained within feature catalog store 140, and provision, to executed web browser 106, data identifying one or more of the available features having feature identifiers consistent with of the specified query, which executed web browser 106 may cause display device 109A to present within a corresponding portions of digital interface 314, e.g., at a position proximate to text box 334.

Alternatively, the specified query may include a structured or unstructured textual query characterizing an available feature, and NLP module 158 of executed feature search engine 156 may receive the structured or unstructured textual content from analyst device 102, may apply a trained natural-language processing technique (e.g., a trained artificial-intelligence process, such as a trained neural network) to portions of the structured or unstructured textual query and to the textual descriptions of corresponding ones of the available features (e.g., as maintained within feature catalog store 140). Based on the application of the trained natural-language processing operation to the portions of the structured or unstructured textual query and to the textual descriptions of corresponding ones of the available features, executed NLP module 158 may identify a specified or threshold number of the available features having feature identifiers that represent matches to the structured or unstructured textual query (e.g., that represent “candidate” matches), and to provide data identifying the specified or threshold number of the available features to analyst device 102, e.g., as results of a “smart” search for presentation within digital interface 314.

In some instances, upon selection of the available features consistent with the customer-specific observation unit and the split-based aggregation method, analyst 101 may provide additional input to input device 109B that selects a “Continue” icon 336 within digital interface 314. Referring to FIG. 3F, analyst 101 may provision the additional input, e.g., analyst input 336, indicative of the selection of the “Continue” icon 336 to input device 109B, which may route corresponding elements of input data 338 to executed web browser 106. Based on the elements of input data 338, executed web browser 106 may generate elements of query data 340 that include dimensional data 342 identifying the selected entity-specific dimension (e.g., the “customer” dimension), aggregation data 344 that identified the selected split-based aggregation method, and feature identifiers 346 associated with each of the selected features. In some instances, analyst device 102 may transmit the elements of query data 340 across network 120 to computing system 130, e.g., within the established, web-based interactive computational environment.

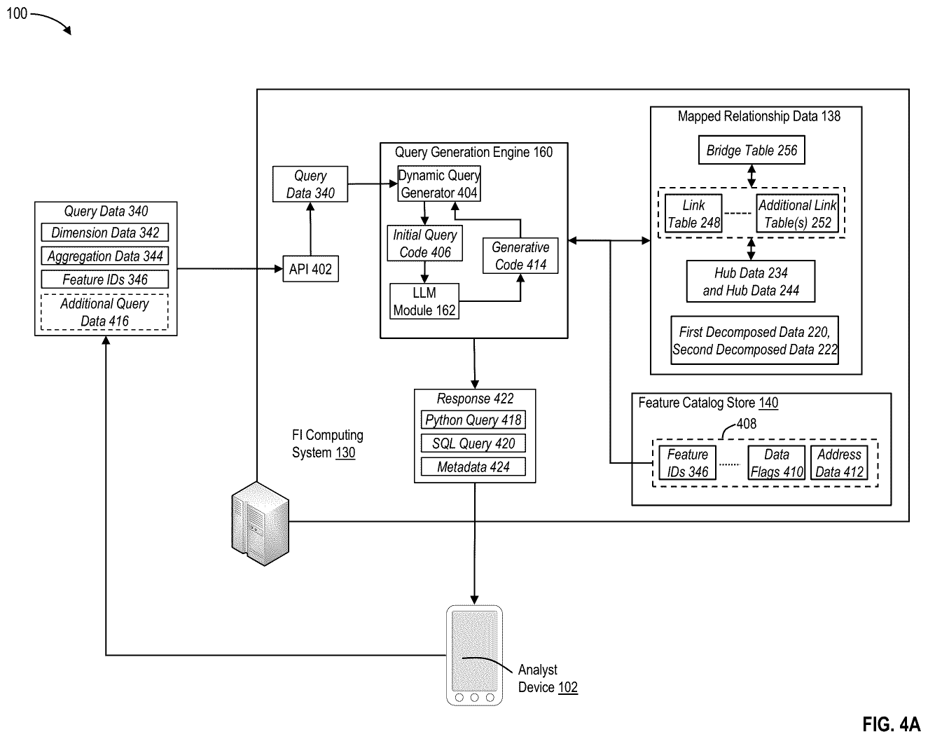

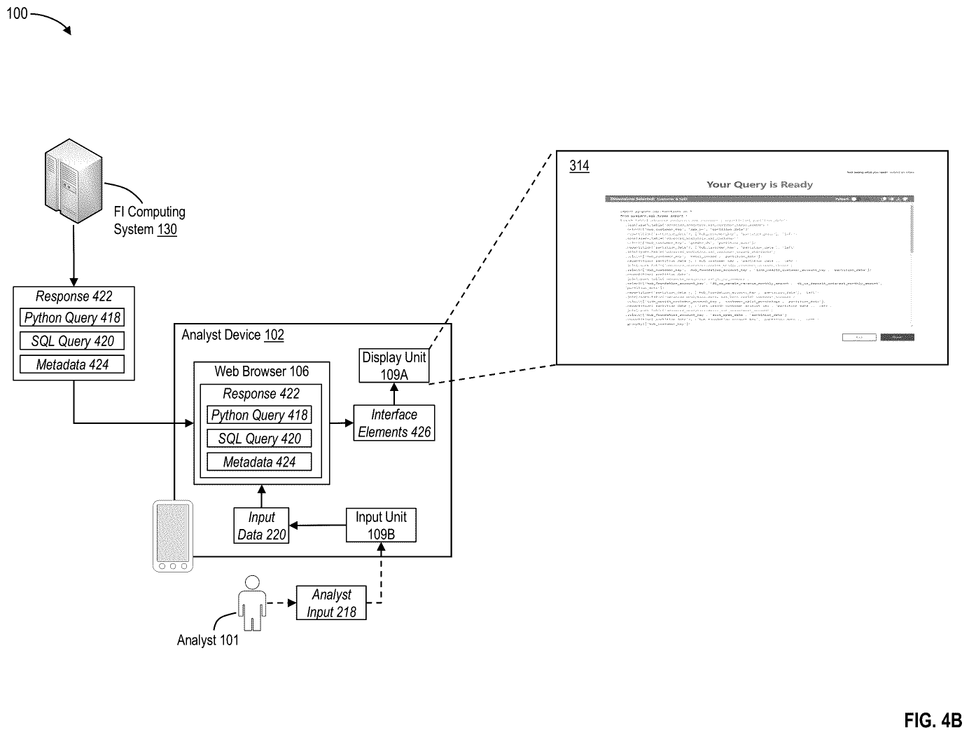

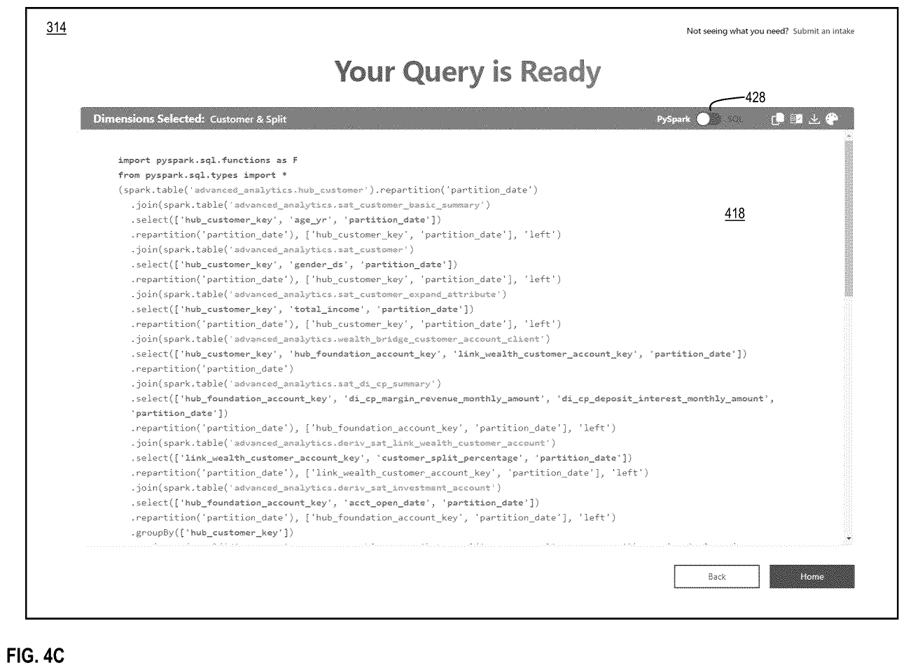

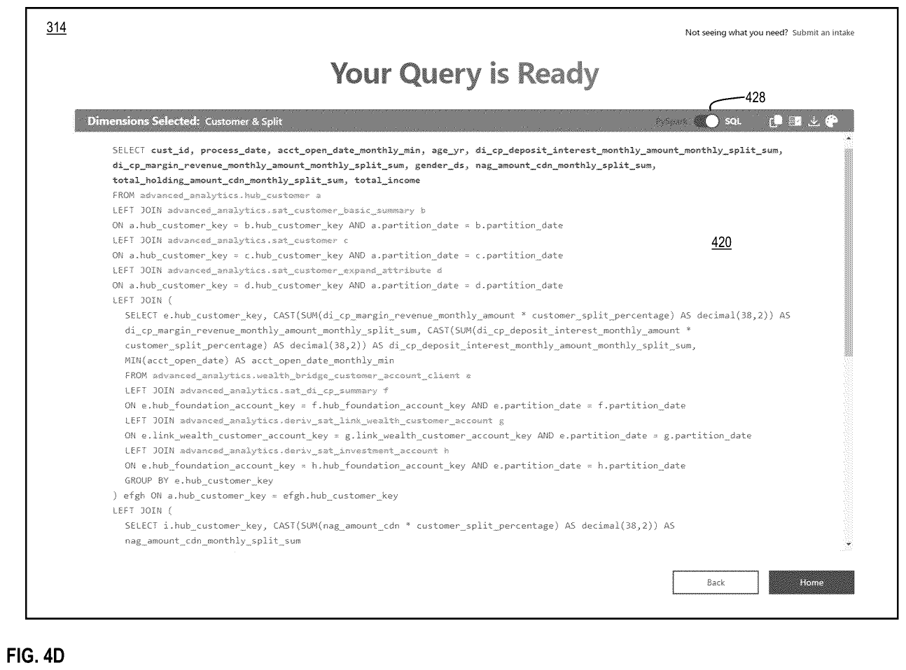

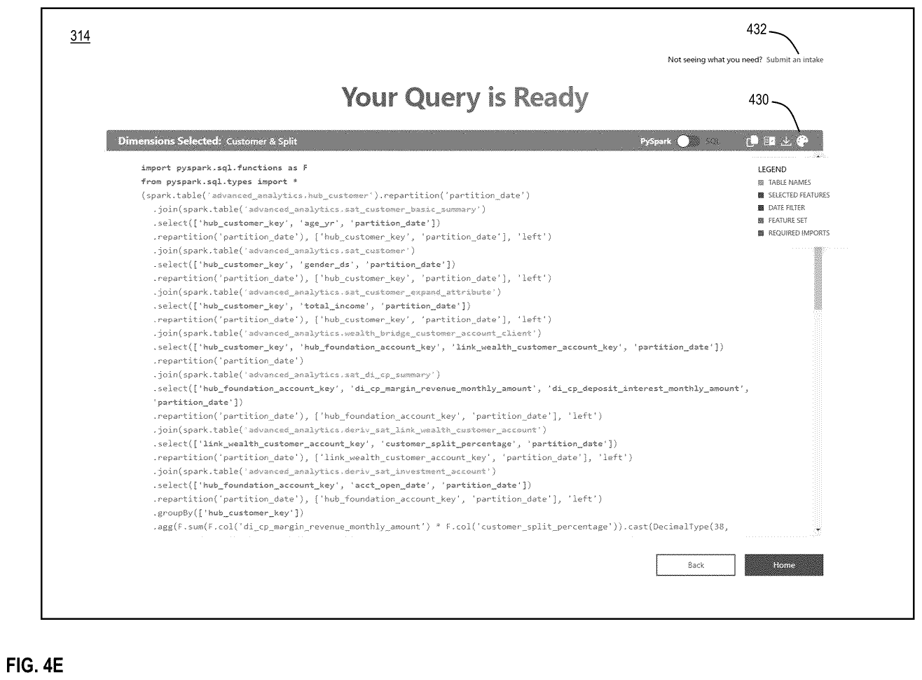

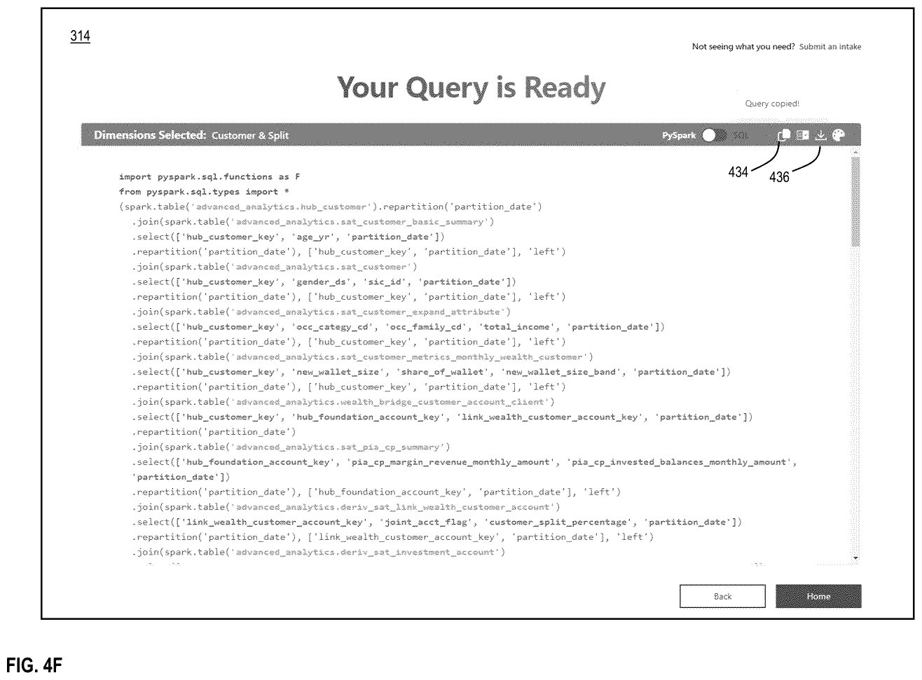

Referring to FIG. 4A, a programmatic interface associated with a query generation engine 160 executed by the one or more processors of computing system 130, such as application programming interface (API) 402, may receive the elements of query data 340 and route the elements of query data 340 to executed query generation engine 160. In some instances, a dynamic query generator 404 of executed query generation engine 160 may receive the elements of query data 340, which includes the dimensional data 342, aggregation data 344, and feature identifiers 346 described herein. Based on portions of mapped relationship data 138 and feature catalog store 140, executed dynamic query generator 404 may generate elements of initial query code 406 that, upon execution, join together, and/or apply one or more database operation to, discrete data tables maintained within mapped relationship data 138 associated with the selected features (e.g., the satellite and derived satellite tables described herein), apply the temporal filter described herein, and generate a feature data table that includes each of the selected features.

By way of example, executed dynamic query generator 404 may receive the elements of query data 340, dimensional data 342, aggregation data 344, and feature identifiers 346, and may perform operation that access feature catalog store 140 and identify a subset 408 of data records that include feature identifiers 346, e.g., that identify and characterize the selected features. Each of the feature-specific data records within subset 408 may, for example, include a corresponding one of data flags 410, which indicates that the corresponding one of the selected features represents an extracted feature, or alternatively, a derived feature, and corresponding element of address data 412. As described herein, the corresponding element of address data 412 may include address data that identifies an identifier of a corresponding satellite (or derived satellite) table within mapped relationship data 138 that maintains values of the extracted or derived feature and a hash key of the hub table associated with the corresponding satellite (or derived satellite) table within mapped relationship data 138. Additionally, or alternatively, and for a derived feature, the corresponding element of address data 412 may specify identifiers of corresponding satellite (or derived satellite) data tables, and the hash key of corresponding hub tabled, within mapped relationship data 138, along with operation data characterizing the one or more database operations applicable to the corresponding satellite (or derived satellite) data tables.

In some instances, executed dynamic query generator 404 may perform operations, for each of these selected features associated with feature identifiers 346, that process corresponding ones of subset 408 of feature-specific data records and generate a corresponding subset of initial query code 406 for each of the selected features in accordance with the corresponding element of address data 412 and based on mapped relationship data 138. As described herein, the elements of initial query code 406 may be structured in a Python™ format, in a structured query language (SQL) format, or in any additional, or alternate, appropriate format. Further, executed dynamic query generator 404 may provision the elements of initial query code 406 to inputs of an LLM module 162 of executed query generation engine 160.

Executed LLM module 162 may apply a trained, large-language model to the elements of initial query code 406, and based on the application of the trained, large-language model to the elements of initial query code 406, executed LLM module 162 may generate one or more additional elements of query code, e.g., elements of generative code 414. The elements of generative code 414 may, for example, apply one or more customized, analyst-and use-case-specific manipulations or filters to the features generated by the elements of initial query code 406 (e.g., one or more additional temporal filters or temporal aggregations, other manipulations, etc.), which may be maintained or specified within one or more elements of additional query data 416 within query data 340. As described herein, the large-language model may include, but is not limited to, a pre-trained generative transformer, such as a GPT 3.5 or GPT 4 process (e.g., a ChatGPT process), and executed LLM module 162 may provision the elements of generative code 414 to executed dynamic query generator 404.

In some instances, executed dynamic query generator 404 may concatenate the elements of initial query code 406 and the elements of generative code 414, and generate augmented elements of query code in Python™ format (e.g., Python query 418) and in SQL format (e.g., SQL query 420), and package Python query 418 and SQL query 420 into corresponding portions of a response 422. In some instances, executed dynamic query generator 404 may also package, into a portion of response 422, elements of metadata 424 that identify, among other things, the selected entity-specific dimension, the selected customer-specific observation unit, and the selected split-based aggregation method, the selected features, and the specified temporal filter, and executed query generation engine 160 may perform operations that cause computing system 130 to transmit response 422 across network 120 to analyst device 102.

Referring to FIG. 4B, executed web browser 106 may receive response 422, and may store the elements of Python query 418, SQL query 420, and metadata 424 within a portion of memory 105 (not illustrated in FIG. 4B). Executed web browser 106 may also process the received elements of Python query 418, SQL query 420, and metadata 424, and generate corresponding interface elements 426, which may be provisioned to display device 109A. As illustrated in FIG. 4B, display device 109A may render an initial portion of interface elements 426 for presentation within digital interface 314, e.g., as a “query page” of the web-based GUI.

Referring to FIG. 4C, digital interface 314 may present, within the query page, all or a selected portion of Python query 418. Further, to view the generated elements of query code in SQL format, analyst 101 may provide additional input to input device 109B that selects toggle 428, and based on the additional input, executed web browser 106 may cause display device 109A to present, within digital interface 314, all or a selected portion of SQL query 420, e.g., as illustrated in FIG. 4D. In some instances, to facilitate explainability of the elements of Python query 418 or SQL query 420, analyst 101 may provide additional input to input device 109B that selects a “legend” icon 430 within FIG. 4E, which may cause display device 109A to present, within digital interface 314, a legend that visually associates portions of the Python query 418 or SQL query 420 with corresponding colors, including, but not limited to, those portions of Python query 418 or SQL query 420 that refer to table names, selected features, temporal filters, feature sets, required imports, or generative code.

Further, in some examples, analyst 101 may elect to provide feedback that requests the addition of a particular extracted or derived feature, or of a particular filter, into the analytical feature store. As illustrated in FIG. 4E, and to facilitate the submission of such feedback, analyst 101 may provide additional input to input device 109B that selects an “intake” icon 432 of digital interface 314, which may trigger a presentation of an intake form that prompts analyst 101 to provide input that characterizes the particular extracted or derived feature, or of a particular filter. Based on corresponding elements of intake data generate by executed web browser 106 and transmitted to computing system 130, executed feedback engine 166 may process the intake data and may perform any of the exemplary processes described herein to adjudicate the request to add the particular extracted or derived feature, or the particular filter, into the analytical feature store based on one or more internal adjudication processes, e.g., that ensure robust features and filters within the analytical feature store.

Referring to FIG. 4F, analyst 101 may provide additional input to input device 109B that selects a “copy” icon 434 of digital interface 314, which causes executed web browser 106 to copy Python query 418 or SQL query 420 into a local clipboard (e.g., for pasting into another document or into another computing environment) and additionally, or alternatively, that selects a “download” icon 436 of digital interface 314, which causes executed web browser 106 to save a copy of Python query 418 or SQL query 420 within a local memory, such as memory 105 of analyst device 102. In some instances, the established, web-based interactive computational environment, such as a Juypter™ notebook or a Databricks™ notebook, may access the Python query 418 or SQL query 420 (e.g., through a pasting of the copies of Python query 418 or SQL query 420, or by accessing the locally saved Python query 418 or SQL query 420), and may perform operations that, in conjunction with computing system 130, execute the Python query 418 or SQL query 420 and generate the feature table that includes the selected features. In some instances, upon execution by the one or more processors of computing system 130, a validation engine 164 may perform operations that, based on the execution of Python query 418 or SQL query 420, generate elements of validation data characterizing the generation of the feature table, such as, but not limited to, data frames characterizing a number of zero attributions of each of the features, and that store the validation data within the one or more tangible, non-transitory memories of computing system 130, e.g., within a portion of validation data store 144.

Certain of the exemplary processes described herein address existing, technical challenges in the field of data science and analytics by centralizing, optimizing, and open sourcing feature generation and management, and by providing a unique architecture that serves as a bridge between data engineers, data scientists, analysts, and machine learning processes and corresponding. Further, certain of these exemplary processes optimize an end-to-end process of extracting, transforming, and loading data (ETL), develop and provision features for process training and inference, and maintain consistency between training and production environments (e.g., by building analytical datasets to support insights generation by fast iteration of analytics and process construction.

As described herein, and through an implementation of one or more of the exemplary processes described herein, computing system 130 may ingest data from various sources and apply transformations and cleanup processes, and may employ Data Vault 2.0 principles to establish modular data formats and relationships between data tables, and to optimize data processing capabilities and allows for dynamic and efficient feature generation. Further, and as described herein, certain of these exemplary may dynamically map associations and relationships in the data, reducing the need for manual coding and data processing, and provide an analyst-friendly interface that simplifies interactions between end-users, data, and machine learning processes and supports seamless deployment of APIs for machine learning processes.

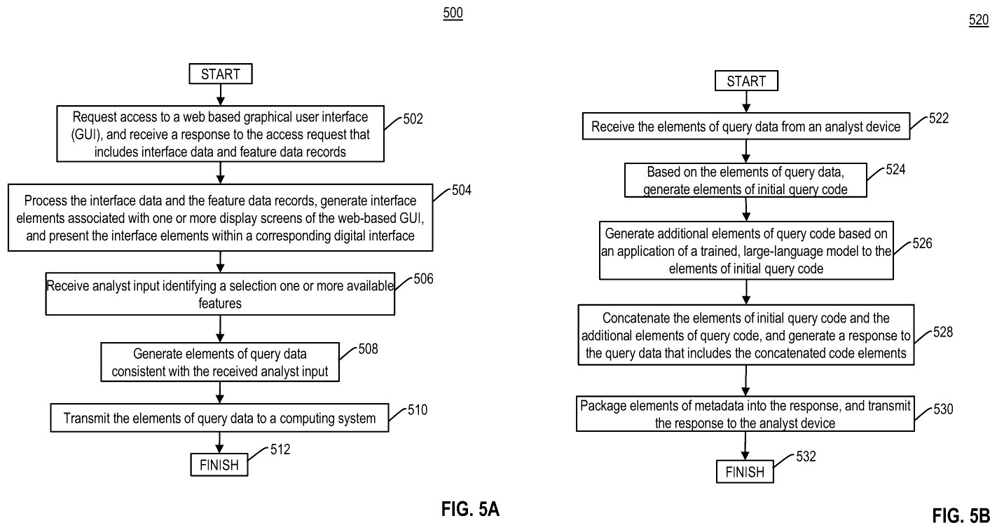

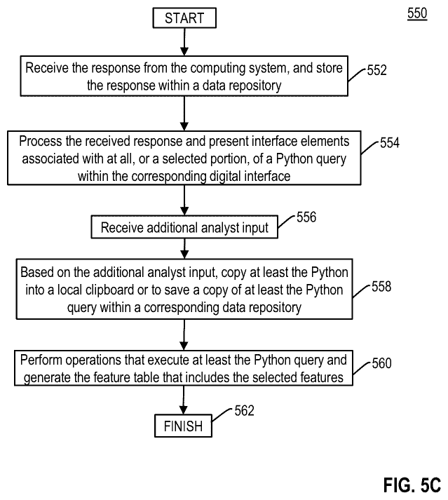

FIGS. 5A. 5B, and 5C are flowcharts of exemplary processes for managing feature generation within interactive, web-based computing environments. As described herein, one or more computing devices operating within environment 100, such as, but not limited to, analyst device 102 operable by analyst 101, may perform one or more of the steps of exemplary process 500 of FIG. 5A and of exemplary process 550 of FIG. 5C, and one or more computing systems, such as, but not limited to, one or more of the distributed components of computing system 130, may perform one or more of the steps of exemplary process 520 of FIG. 5B.

Referring to FIG. 5A, analyst device 102 may perform any of the exemplary processes described herein to request access to a web-based graphical user interface (GUI) associated with feature catalog store 140 maintained at computing system 130, and receive a response to the request from computing system 130 (e.g., in step 502 of FIG. 5A). As described herein, the received response may include elements of interface data that identify and characterize one or more interface elements, and a layout of these interface elements, within an initial display screen of the web-based GUI (e.g., a “landing page”) and within subsequent display screens of the web-based GUI. Further, the received response may also include one or more feature records that identify and characterize one or more available features, which may be extracted or derived from the corresponding ones of the data tables maintained within mapped relationship data 138 using any of the exemplary processes described herein. As described herein, and for a corresponding feature, the feature data records may include, but are not limited to, a corresponding feature identifier (e.g., an alphanumeric feature name, etc.), elements of categorization data identifying a feature category that includes the corresponding feature (e.g., an alphanumeric category name, etc.), elements of dimensionality data that characterizes a dimension associated with the corresponding feature (e.g., a corresponding event or entity dimension, etc.), elements of type data that characterizes a corresponding feature type (e.g., text-based, binary, categorical, or floating-point numerical, etc.), and textual content that describes (e.g., in natural, human-readable language) the feature and a relationship of that feature to a corresponding customer, account, transactional, or interaction-specific characteristic or behavior of the a corresponding customer.

Further, in step 504 of FIG. 5A, analyst device 102 may perform operations, described herein, that process the elements of interface data and each of the feature data records, and that generate interface elements associated with one or more display screens of the web-based GUI based on the processed elements of interface data and the feature data records, and that present the interface elements within a corresponding digital interface, e.g., within the landing page of the web-based GUI and across one or more subsequent display screens of the web-based GUI. For example, and as described herein, the presented interface elements may prompt analyst 101 to provide input to analyst device 102 (e.g., via input device 102B) that selects a corresponding dimension of the available features, that selects an observation unit and granularity of a selected event dimension or an observation unit and aggregation method of a selected entity dimension, and further, that selects one or more of the available features associated with the selected dimension, the selected observation unit, and the selected granularity or aggregation method.

In some instances, analyst device 102 may receive input analyst 101 (e.g., via input device 102B) indicative of the selected dimension and observation unit, the selected granularity or aggregation method, and the selected subset of the available features (e.g., in step 506 of FIG. 5A), and may perform any of the exemplary processes described herein to generate elements of query data consistent with the received input from analyst 101 (e.g., in step 508 of FIG. 5A). As described herein, the elements of query data may include, among other things, elements of dimensional data identifying the selected entity-or event-specific dimension or observation unit, data (e.g., the “customer” dimension), data specifying the selected granularity or aggregation method, and the feature identifiers of each of the selected features. Analyst device 102 may, in some instances, transmit the generated elements of query data across network 120 to computing system 130 (e.g., in step 510 of FIG. 5A), and exemplary process 500 is complete in step 512.

Referring to FIG. 5B, computing system 130 may receive the elements of query data from analyst device 102 across network 120 (e.g., in step 522 of FIG. 5B), and computing system 130 may perform any of the exemplary processes described herein to generate elements of initial query code that, upon execution, generate a feature data table that includes each of the selected features (e.g., in step 524 of FIG. 5B). As described herein, the elements of initial query code may be structured in a Python™ format, in a structured query language (SQL) format, or in any additional, or alternate, appropriate format. Further, computing system 130 may also apply a trained, large-language model to the elements of initial query code, and based on the application of the trained, large-language model to the elements of initial query code, computing system 130 may perform any of the exemplary processes described herein to generate one or more additional elements of query code, such as elements of generative code that apply one or more customized, analyst-and use-case-specific manipulations or filters to the features generated by the elements of initial query code (e.g., in step 526 of FIG. 5B). As described herein, the large-language model may include, but is not limited to, a pre-trained generative transformer, such as a GPT 3.5 or GPT 4 process (e.g., a ChatGPT process).

In some instances, computing system 130 may also perform any of the exemplary processes described herein to concatenate the elements of initial query code and the elements of generative code, and generate augmented elements of query code in Python™ and in SQL format, which computing system 130 may package into corresponding portions of a response to the query data (e.g., in step 528 of FIG. 5B). In some instances, system 130 may also package, into a portion of the response, elements of metadata that identify, among other things, the selected entity-specific dimension, the selected customer-specific observation unit, and the selected aggregation method or granularity, the selected features, and any specified temporal filter, and computing system 130 may transmit the response across network 120 to analyst device 102 (e.g., in step 530 of FIG. 5B), Exemplary process 520 is then complete in step 532.

Referring to FIG. 5C, analyst device 102 may receive the response, which include the elements of the Python query, the SQL query 420, and the metadata, and may store the response within a corresponding data repository (e.g., in step 552 of FIG. 5C). Analyst device 102 may operation, described herein, that process the received elements of the Python query, the SQL query, and the metadata, and present interface elements associated with at all, or a selected portion, of the elements of the Python query within the at least one display screen of the web-based GUI (e.g., in step 554 of FIG. 5C). Analyst device 102 may, in some instances, receive additional input from analyst 101 (e.g., in step 556 of FIG. 5C), and based on the additional input, analyst device 102 may perform any of the exemplary processes described herein to copy the Python query (or the SQL query) into a local clipboard or to save a copy of the Python query (or the SQL query 420) within the corresponding data repository (e.g., in step 558 of FIG. 5C). By way of example, the established, web-based interactive computational environment, such as a Juypter™ notebook or a Databricks™ notebook executed at analyst device 102, may access the Python query or the SQL query (e.g., through a pasting of the copies of the Python query or the SQL query, or by accessing the locally saved Python query or the SQL query), and may perform operations that, in conjunction with computing system 130, execute the Python query or the SQL query and generate the feature table that includes the selected features (e.g., in step 560 of FIG. 5C). Exemplary process 550 is then complete in step 562.

### C. Exemplary Hardware and Software Implementations

Embodiments of the subject matter and the functional operations described in this disclosure can be implemented in digital electronic circuitry, in tangibly-embodied computer software or firmware, in computer hardware, including the structures disclosed in this specification and their structural equivalents, or in combinations of one or more of them. Embodiments of the subject matter described in this disclosure, including web browser 106, data integration engine 148, relationship mapping engine 150, feature mapping engine 152, interface engine 154, feature search engine 156, NLP module 158, query generation engine 160, LLM module, validation engine 164, feedback engine 166, application programming interfaces (APIs) 210, 304, and 402, decomposition module 218, hub generation module 224, link generation module 246, bridge generation module 254, and dynamic query generator 404, can be implemented as one or more computer programs, i.e., one or more modules of computer program instructions encoded on a tangible non-transitory program carrier for execution by, or to control the operation of, a data processing apparatus (or a computing system). Additionally, or alternatively, the program instructions can be encoded on an artificially-generated propagated signal, such as a machine-generated electrical, optical, or electromagnetic signal that is generated to encode information for transmission to suitable receiver apparatus for execution by a data processing apparatus. The computer storage medium can be a machine-readable storage device, a machine-readable storage substrate, a random or serial access memory device, or a combination of one or more of them

The terms “apparatus,” “device,” and “system” refer to data processing hardware and encompass all kinds of apparatus, devices, and machines for processing data, including by way of example a programmable processor, a computer, or multiple processors or computers. The apparatus, device, or system can also be or further include special purpose logic circuitry, such as an FPGA (field programmable gate array) or an ASIC (application-specific integrated circuit). The apparatus, device, or system can optionally include, in addition to hardware, code that creates an execution environment for computer programs, such as code that constitutes processor firmware, a protocol stack, a database management system, an operating system, or a combination of one or more of them.

A computer program, which may also be referred to or described as a program, software, a software application, a module, a software module, a script, or code, can be written in any form of programming language, including compiled or interpreted languages, or declarative or procedural languages, and it can be deployed in any form, including as a stand-alone program or as a module, component, subroutine, or other unit suitable for use in a computing environment. A computer program may, but need not, correspond to a file in a file system. A program can be stored in a portion of a file that holds other programs or data, such as one or more scripts stored in a markup language document, in a single file dedicated to the program in question, or in multiple coordinated files, such as files that store one or more modules, sub-programs, or portions of code. A computer program can be deployed to be executed on one computer or on multiple computers that are located at one site or distributed across multiple sites and interconnected by a communication network.

The processes and logic flows described in this specification can be performed by one or more programmable computers executing one or more computer programs to perform functions by operating on input data and generating output. The processes and logic flows can also be performed by, and apparatus can also be implemented as, special purpose logic circuitry, such as an FPGA (field programmable gate array) or an ASIC (application-specific integrated circuit).

Computers suitable for the execution of a computer program include, by way of example, general or special purpose microprocessors or both, or any other kind of central processing unit. Generally, a central processing unit will receive instructions and data from a read-only memory or a random-access memory or both. The essential elements of a computer are a central processing unit for performing or executing instructions and one or more memory devices for storing instructions and data. Generally, a computer will also include, or be operatively coupled to receive data from or transfer data to, or both, one or more mass storage devices for storing data, such as magnetic, magneto-optical disks, or optical disks. However, a computer need not have such devices. Moreover, a computer can be embedded in another device, such as a mobile telephone, a personal digital assistant (PDA), a mobile audio or video player, a game console, a Global Positioning System (GPS) or an assisted Global Positioning System (AGPS) receiver, or a portable storage device, such as a universal serial bus (USB) flash drive, to name just a few.

Computer-readable media suitable for storing computer program instructions and data include all forms of non-volatile memory, media and memory devices, including by way of example semiconductor memory devices, such as EPROM, EEPROM, and flash memory devices; magnetic disks, such as internal hard disks or removable disks; magneto-optical disks; and CD-ROM and DVD-ROM disks. The processor and the memory can be supplemented by, or incorporated in, special purpose logic circuitry.

To provide for interaction with a user, such as user of analyst device 102, embodiments of the subject matter described in this specification can be implemented on a computer having a display device, such as a CRT (cathode ray tube) or LCD (liquid crystal display) monitor, for displaying information to the user and a keyboard and a pointing device, such as a mouse or a trackball, by which the user can provide input to the computer. Other kinds of devices can be used to provide for interaction with a user as well; for example, feedback provided to the user can be any form of sensory feedback, such as visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's device in response to requests received from the web browser.

Implementations of the subject matter described in this specification can be implemented in a computing system that includes a back-end component, such as a data server, or that includes a middleware component, such as an application server, or that includes a front-end component, such as a client computer having a graphical user interface or a Web browser through which a user can interact with an implementation of the subject matter described in this specification, or any combination of one or more such back-end, middleware, or front-end components. The components of the system can be interconnected by any form or medium of digital data communication, such as a communication network. Examples of communication networks include a local area network (LAN) and a wide area network (WAN), such as the Internet.

The computing system can include clients and servers. A client and server are generally remote from each other and typically interact through a communication network. The relationship of client and server arises by virtue of computer programs running on the respective computers and having a client-server relationship to each other. In some implementations, a server transmits data, such as an HTML page, to a user device, such as for purposes of displaying data to and receiving user input from a user interacting with the user device, which acts as a client. Data generated at the user device, such as a result of the user interaction, can be received from the user device at the server.

While this specification includes many specifics, these should not be construed as limitations on the scope of the disclosure or of what may be claimed, but rather as descriptions of features specific to particular embodiments of the disclosure. Certain features that are described in this specification in the context of separate embodiments may also be implemented in combination in a single embodiment. Conversely, various features that are described in the context of a single embodiment may also be implemented in multiple embodiments separately or in any suitable sub-combination. Moreover, although features may be described above as acting in certain combinations and even initially claimed as such, one or more features from a claimed combination may in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products.

In each instance where an HTML file is mentioned, other file types or formats may be substituted. For instance, an HTML file may be replaced by an XML, JSON, plain text, or other types of files. Moreover, where a table or hash table is mentioned, other data structures (such as spreadsheets, relational databases, or structured files) may be used.

Various embodiments have been described herein with reference to the accompanying drawings. It will, however, be evident that various modifications and changes may be made thereto, and additional embodiments may be implemented, without departing from the broader scope of the disclosed embodiments as set forth in the claims that follow.

Further, unless otherwise specifically defined herein, all terms are to be given their broadest possible interpretation including meanings implied from the specification as well as meanings understood by those skilled in the art and/or as defined in dictionaries, treatises, etc. It is also noted that, as used in the specification and the appended claims, the singular forms “a,” “an,” and “the” include plural referents unless otherwise specified, and that the terms “comprises” and/or “comprising,” when used in this specification, specify the presence or addition of one or more other features, aspects, steps, operations, elements, components, and/or groups thereof. Moreover, the terms “couple,” “coupled,” “operatively coupled,” “operatively connected,” and the like should be broadly understood to refer to connecting devices or components together either mechanically, electrically, wired, wirelessly, or otherwise, such that the connection allows the pertinent devices or components to operate (e.g., communicate) with each other as intended by virtue of that relationship. In this disclosure, the use of “or” means “and/or” unless stated otherwise. Furthermore, the use of the term “including,” as well as other forms such as “includes” and “included,” is not limiting. In addition, terms such as “element” or “component” encompass both elements and components comprising one unit, and elements and components that comprise more than one subunit, unless specifically stated otherwise. Additionally, the section headings used herein are for organizational purposes only and are not to be construed as limiting the described subject matter.

The foregoing is provided for purposes of illustrating, explaining, and describing embodiments of this disclosure. Modifications and adaptations to the embodiments will be apparent to those skilled in the art and may be made without departing from the scope or spirit of the disclosure.

What is claimed is:

1. An apparatus, comprising:
a communications interface;
a memory storing instructions; and
at least one processor coupled to the communications interface and to the memory, the at least one processor being configured to execute the instructions to:
transmit, to a device via the communications interface, first data characterizing a plurality of features, the first data causing an application program executed by the device to present interface elements associated with the features within one or more portions of a digital interface;
receive second data that identifies at least a subset of the features from the device via the communications interface, and based on the second data, generate, for each of the subset of the features, elements of executable code associated with a calculation of a corresponding feature value; and
transmit third data that includes the elements of executable code to the device via the communications interface, the third data causing the executed application program to present the elements of executable code within one or more additional portions of the digital interface.

2. The apparatus of claim 1, wherein:
the second data comprises feature identifiers associated with the subset of the features; and
the at least one processor is further configured to execute the instructions to:
obtain feature data records associated with the feature identifiers; and
generate the elements of executable code associated with each of the subset of the features based on a corresponding ones of the feature data records.

3. The apparatus of claim 2, wherein the at least one processor is further configured to execute the instructions to:
obtain an identifier of a mapped data table from a corresponding one of the feature data records, the corresponding one of the feature data records being associated with a corresponding one of the subset of the features; and
generate the elements of executable code associated with the corresponding one of the subset of the features based on the identifier.

4. The apparatus of claim 1, wherein the at least one processor is further configured to execute the instructions to generate, based on the second data, first elements of executable code and second elements of executable code, the first elements of executable code being associated with an extraction of a corresponding, first feature value from a mapped data table, and the second elements of executable code being associated with a calculation of a corresponding, second feature value based on an application of one or more database operations to corresponding mapped data tables.

5. The apparatus of claim 1, wherein:
the at least one processor is further configured to generate elements of metadata that characterize the generation of the elements of executable code, the elements of metadata comprising a feature identifier of each of the subset of the features, a feature category associated with each of the subset of the features, and elements of textual data that describe each of the subset of the features;
the third data comprises the elements of executable code and the elements of the metadata; and
the third data causes the executed application program to present the elements of metadata within one or more further portions of the digital interface.

6. The apparatus of claim 1, wherein the at least one processor is further configured to execute the instructions to generate the elements of executable code in accordance with at least one of a Python format or a structured query language (SQL) format.

7. The apparatus of claim 1, wherein:
the first data comprises a feature category associated with each of the subset of features and a feature identifier associated with each of the subset of features;
the executed application program causes the device to present interface elements representative of each of the feature identifiers and the corresponding feature categories within the one or more portions of the digital interface.

8. The apparatus of claim 1, wherein:
the elements of executable code comprise one or more initial elements of executable code; and
the at least one processor is further configured to execute the instructions to:
based on an application of a trained, large-language process to the one or more initial elements of executable code, generate one of more additional elements of executable code; and
perform operations that concatenate the initial and additional elements of executable code, and that generate the third data based on the concatenation of the initial and additional elements of executable code.

9. The apparatus of claim 8, wherein the trained, large-language process comprises a pre-trained generative transformer, and the one of more additional elements of executable code comprise elements of generative code.

10. The apparatus of claim 1, wherein the at least one processor is further configured to execute the instructions to:
receive a structured or unstructured textual query from the device via the communications interface;
identify a feature identifier based on an application of a natural-language processing operation to portions of the structured or unstructured textual query; and
transmit a response to the structured or unstructured textual query that includes the feature identifier to the device via the communications interface, the response causing the executed application program to present at least one additional interface element associated with the feature identifier within the one or more portions of the digital interface.

11. The apparatus of claim 1, wherein the execute application program causes the device to execute the elements of executable code and generate a feature table that includes feature values associated with the subset of the available features.

12. The apparatus of claim 1, wherein the plurality of features is available to one or more machine-learning or artificial-intelligence processes.

13. A computer-implemented method, comprising:
using at least one processor, transmitting, to a device, first data characterizing a plurality of features, the first data causing an application program executed by the device to present interface elements associated with the features within one or more portions of a digital interface;
receiving, from the device, and using the at least one processor, second data that identifies at least a subset of the features, and based on the second data, generating, using the at least one processor, elements of executable code associated with a calculation of a corresponding feature value for each of the subset of the features; and
transmitting third data that includes the elements of executable code to the device using the at least one processor, the third data causing the executed application program to present the elements of executable code within one or more additional portions of the digital interface.

14. A device, comprising:
a communications interface;
a memory storing instructions; and
at least one processor coupled to the communications interface and to the memory, the at least one processor being configured to execute the instructions to:
receive, via the communication interface, first data characterizing a plurality of features, and perform operations that present interface elements associated with the features within one or more portions of a digital interface;
obtain second data indicative of a selection of at least a subset of the features, and transmit at least a portion of the second data to a computing system via the communications interface, the computing system being configured to generate, based on the portion of the second data, elements of executable code associated with a calculation of a corresponding feature value for each of the subset of the features; and
receive third data that includes the elements of executable code to the computing system via the communications interface, and perform operations that present the elements of executable code within one or more additional portions of the digital interface.

15. The device of claim 14, wherein the at least one processor is further configured to execute the instructions to execute the elements of executable code, and to generate a feature table that includes the feature values associated with the subset of the features.

16. The device of claim 14, further comprising an input device coupled to the at least one processor, wherein the at least one processor is further configured to execute the instructions to:
receive, via the input device, elements of input data associated with the selection of at least the subset of the features; and
generate the second data based on the elements of input data.

17. The device of claim 16, wherein:
the elements of input data comprise feature identifiers associated with the subset of the features; and
the second data comprises the feature identifiers; and
the computing system is further configured to:
obtain feature data records associated with the feature identifiers from a data repository; and
generate the elements of executable code associated with each of the subset of the features based on a corresponding one of the feature data records.

18. The device of claim 14, wherein:
the third data further comprises metadata characterizing the generation of the elements of executable code, the elements of metadata comprising a feature identifier of each of the subset of the features, a feature category associated with each of the subset of the features and elements of textual data that describe each of the subset of the features; and
the at least one processor is further configured to execute the instructions to present the elements of metadata within one or more further portions of the digital interface.

19. The device of claim 14, wherein:
the elements of executable code comprise one or more initial elements of executable code; and
the computing system is further configured to:
based on an application of a trained, large-language process to the one or more initial elements of executable code, generate one of more additional elements of executable code; and
perform operations that concatenate the initial and additional elements of executable code, and that generate the third data based on the concatenation of the initial and additional elements of executable code.

20. The device of claim 14, wherein the computing system is further configured to generate the elements of executable code in accordance with at least one of a Python format or a structured query language (SQL) format.
